(19) United States
(12) Patent Application Publication
(10) Pub. No.: US 2024/0375043 A1
(43) Pub. Date: Nov. 14, 2024

(54) COMPOSITE SEPARATION STRUCTURE

(71) Applicants: Mitsubishi Chemical Corporation, Tokyo (JP); JAPAN TECHNOLOGICAL RESEARCH ASSOCIATION OF ARTIFICIAL PHOTOSYNTHETIC CHEMICAL PROCESS, Tokyo (JP)

(72) Inventors: Kiminori SATOU, Kitakyushu-shi (JP); Hideyoshi HORIE, Yokohama-shi (JP); Tomohisa KIKUCHI, Kamisu-shi (JP); Hidekazu MIYAGI, Machida-shi (JP); Mikio HAYASHI, Kitakyushu-shi (JP); Takahiko TAKEWAKI, Yokohama-shi (JP)

(73) Assignees: Mitsubishi Chemical Corporation, Tokyo (JP); JAPAN TECHNOLOGICAL RESEARCH ASSOCIATION OF ARTIFICIAL PHOTOSYNTHETIC CHEMICAL PROCESS, Tokyo (JP)

(21) Appl. No.: 18/778,903

(22) Filed: Jul. 19, 2024

Related U.S. Application Data
(63) Continuation of application No. PCT/JP2023/001582, filed on Jan. 19, 2023.

(30) Foreign Application Priority Data
Jan. 20, 2022 (JP) 2022-007409

(51) Int. Cl. B01D 53/22

(52) U.S. Cl. CPC B01D 53/228; B01D 2256/12; B01D 2256/22; B01D 2257/108; B01D 2257/80

(57) ABSTRACT

A composite separation structure may include a substrate section, a first separation section disposed in contact with the substrate section, and a second separation section disposed not in contact with the substrate section but in contact with the first separation section. The second separation section may be amorphous and have a thickness from an end portion in contact with the first separation section to the opposite end portion of 5 nm or more and 200 nm or less. Such a composite separation structure may be capable of separating gases having various small kinetic diameters (kinetic diameters) with high separability, and particularly capable of realizing the separation or concentration of a gas mixture containing a gas having a kinetic diameter of 4 Å or less.

### TECHNICAL FIELD

The present invention relates to a composite separation structure for permeating a substance having high permeability from a mixed gas containing a plurality of gas components and concentrating a substance having low permeability, and a separation and concentration method using the composite separation structure.

### BACKGROUND ART

In recent years, importance has been placed on hydrogen as sustainable clean energy, and the development of techniques for separating and generating hydrogen has progressed. For example, it is necessary to separate and purify carbon dioxide (CO₂) and hydrogen (H₂) generated by a water shift reaction, and to separate and purify hydrogen (H₂) from organic hydride as a hydrogen carrier. In addition, it is necessary to separate and purify hydrogen (H₂) from a mixed gas of hydrogen (H₂), oxygen (O₂) and water vapor (H₂O) generated from water splitting by a photocatalyst.

Conventionally, gas separation techniques such as chemisorption and PSA (pressure swing adsorption) have been used. However, separation by adsorption/absorption such as PSA (pressure swing adsorption) requires a step of desorbing the adsorbed/absorbed gas and is a batch process, so plural units are required to make it a continuous process. In addition, regeneration of the adsorbent requires energy. On the other hand, the membrane separation method, which is one of the gas separation and concentration methods, enables continuous separation and can reduce the equipment scale.

As a method of gas separation by a separation membrane, there is a method using a polymer separation membrane. However, although the polymer separation membrane has excellent processability, there is a problem in that it has combustibility. For example, it cannot be used in the separation of a mixed gas containing hydrogen and oxygen which has a possibility of combustion, explosion, or detonation.

Further, a carbon membrane and a silica membrane have been proposed as separation membranes having sub-nanometer pores to separate hydrogen from a mixed gas (Non-Patent Literatures 2 and 3). Among these, the carbon membrane cannot be used for separation of a mixed gas containing hydrogen and oxygen, which has a possibility of combustion, explosion, or detonation, like a polymer membrane. On the other hand, the silica membrane has poor stability against water and water vapor, and it is not suitable for the separation and purification of hydrogen (H₂) from a mixed gas of hydrogen (H₂), oxygen (O₂) and water vapor (H₂O) generated by water splitting by a photocatalyst.

In order to solve these problems, a zeolite separation membrane (defined as a “zeolite simple substance separation structure” in the description herein) has been proposed as a porous inorganic membrane having good water resistance, chemical resistance, oxidation resistance, heat resistance and pressure resistance. Since the zeolite separation membrane has crystallinity and has regular sub-nanometer pores, it results in uniform pore size, high molecular sieving effect, and excellent separation performance. Further, it has water resistance due to its crystallinity and it has excellent stability under conditions in the presence of water vapor.

### CITATION LIST

### Patent Literature (PTL)

PTL 1: JP 2015-44162 A
PTL 2: JP 2015-44163 A
PTL 3: JP 2020-131184 A

### Non-Patent Literature (NPL)

NPL 1: Kiyoshi Yamada et al., Separation of CH₃COOH/H₂O Mixture by Pervaporation through Silylated Silicalite Membrane, MEMBRANE, 22 (4), 200-205 (1997)
NPL 2: Masakoto Kanezashi, Tailoring the Silica Network Structure for Highly Permeable Gas Separation Membrane and Evaluation of Gas Permeation Properties, MEMBRANE, 41 (4), 183-188 (2016)
NPL 3: Kazuhiro Tanaka and Yoshihisa Sakata, Present and Future Prospects of Hydrogen Production Process Constructed by the Combination of Photocatalytic H₂O Splitting and Membrane Separation Process, MEMBRANE, 36 (3), 113-121 (2011)
NPL 4: COLLECTION OF SIMULATED XRD POWDER PATTERNS FOR ZEOLITE Third Revised Edition (1996), ELSEVIER
NPL 5: Halil Kalipcilar et al., “Synthesis and Separation Performance of SSZ-13 Zeolite Membranes on Tubular Supports”, Chem. Matter. (2002), 14, 3458-3464
NPL 6: Koichi Awazu, Small rings in amorphous silica, OYO-BUTURI, 74 (7), p. 917-923 (2005)
NPL 7: International Zeolite Association, Database of Zeolite Structure, URL: https://asia.iza-structure.org/IZA-SC/framework.php?STC=CHA

### SUMMARY OF INVENTION

### Technical Problem

Amorphous silica membranes, carbon membranes and organic membranes are known to have a sub-nanometer molecular sieve effect, which are capable of separating gases having various small kinetic diameters (kinetic diameters) with high separability, and in particular, capable of separating a gas mixture containing gas molecules such as hydrogen, helium, nitrogen, oxygen and water vapor having a kinetic diameter of 4 Å or less. However, the amorphous silica membrane is not sufficiently stable against water vapor, and the carbon membrane and the organic membrane are not practical because of the possibility of oxidation and combustion in combustion and explosion under the condition of high-concentration oxygen and oxygen mixed gas. In addition, these separation membranes cannot be expected to have high permeation performance.

PTLs 1 and 2 disclose zeolite membranes formed on inorganic porous supports and disclose that zeolite membranes (zeolite simple substance separation structures) are treated with Si compounds. However, in the experimental results using the zeolite simple substance separation structures described in PTLs 1 and 2, the hydrogen/nitrogen separation performance is not necessarily sufficient, and further improvement is considered to be necessary. It is presumed that this is because the zeolite simple substance separation structures of PTLs 1 and 2 were treated with liquid Si compounds, and thus a sufficiently narrow pore diameter was not formed. Therefore, in order to exhibit sufficient separation performance, it is a problem to realize treatment of the upper end portion of the zeolite simple substance separation structure.

Further, PTL 3 and NPL 1 disclose separation membranes in which zeolite membranes are modified with Si-containing compounds. These membranes are required to treat in high temperature, 220° C. or higher for their surface modifications, and the modified membranes have strong silica membranes properties and are not sufficiently stable. Therefore, in order to exhibit stable and sufficient separation performance, it is a problem to realize the upper end portion of the zeolite simple substance separation structure at a treatment temperature of 200° C. or lower.

An object of the present invention is to provide a composite separation structure, which has solved the problems of the related art, capable of separating gases having various small kinetic diameters (kinetic diameters) with high separability, and particularly capable of realizing the separation or concentration of a gas mixture containing gases with a kinetic diameter of 4 Å or less, and a method for producing the composite separation structure.

In addition, an object of the present invention is to provide a method for producing a mixed gas having a high hydrogen concentration by utilizing a separation or concentration method using the composite separation structure.

### Solution to Problem

As a result of intensive studies to solve the above problems, the present inventors have found that a composite separation structure having certain physical properties has excellent characteristics in separation of a gas mixture, and thus have completed the present invention.

That is, the gist of the present invention resides in the following [1] to [27].

[1] A composite separation structure comprising a substrate section, a first separation section disposed in contact with the substrate section, and a second separation section disposed not in contact with the substrate section but in contact with the first separation section, in which the second separation section has an amorphous structure.

[2] A composite separation structure comprising a substrate section, a first separation section disposed in contact with the substrate section, and a second separation section disposed not in contact with the substrate section but in contact with the first separation section, in which the second separation section is amorphous and has a thickness from an end portion in contact with the first separation section to the opposite end portion of 5 nm or more and 200 nm or less.

[3] A composite separation structure comprising a substrate section, a first separation section disposed in contact with the substrate section, and a second separation section disposed not in contact with the substrate section but in contact with the first separation section, in which the second separation section is amorphous and has a relative density of 1.05 or more and 1.30 or less with respect to the first separation section.

[4] A composite separation structure comprising a substrate section, a first separation section disposed in contact with the substrate section, and a second separation section disposed not in contact with the substrate section but in contact with the first separation section, in which the second separation section has and has an absolute density of 1.58 g/cm³ or more and 1.96 g/cm³ or less.

[5] The composite separation structure according to any one of [1] to [4], in which the substrate section is an inorganic porous material.

[6] The composite separation structure according to any one of [1] to [5], in which the first separation section is zeolite.

[7] The composite separation structure according to [6], in which the zeolite is a zeolite having a 6-membered oxygen ring structure or an 8-membered oxygen ring structure.

[8] The composite separation structure according to [6] or [7], in which the zeolite is in the form of a membrane.

[9] The composite separation structure according to [8], in which a membrane thickness of the zeolite is 0.1 μm or more and 100 μm or less.

[10] The composite separation structure according to any one of [1] to [9], in which main constituent elements of the second separation section are Si and O.

[11] The composite separation structure according to [10], in which the second separation section is in the form of a membrane.

[12] The composite separation structure according to [11], in which the second separation section is a silica membrane having a membrane thickness of 5 nm or more and 200 nm or less.

[12] The composite separation structure according to any one of [1] to [12], in which hydrogen detonating gas having a hydrogen-to-oxygen ratio of 2 and a pressure of 0.2 MPa(G) or less is separated such that a ratio α (H₂/O₂) of hydrogen permeance to oxygen permeance is 10 or more and 110 or less.

[13] A method for producing the composite separation structure according to any one of [1] to [12], the method comprising: forming the first separation section in contact with the substrate section; and then forming the second separation section by exposing an end portion of the first separation section on a side opposite to a side in contact with the substrate section to a gas containing a molecular compound having at least a Si atom.

[15] The method for producing a composite separation structure according to [14], in which the gas containing a molecular compound having a Si atom further contains water vapor.

[16] The method for producing a composite separation structure according to or [15], in which the end portion of the first separation section on the side opposite to the side in contact with the substrate section is exposed to water vapor before being exposed to the gas containing the molecular compound having a Si atom, and the end portion of the second separation section on the side opposite to the side in contact with the first separation section is exposed to water vapor after the second separation section is formed.

[17] The method for producing a composite separation structure according to any one of to [16], in which all the steps are performed at 200° C. or lower.

[18] A separation or concentration method comprising: allowing hydrogen to permeate from a gas to be separated containing at least hydrogen and oxygen by using the composite separation structure according to any one of [1] to [13].

[19] The separation or concentration method according to [18], in which the hydrogen-to-oxygen ratio in the gas to be separated is 2, and the pressure thereof is 0.2 MPa(G) or less.

[20] A separation or concentration method comprising: allowing hydrogen and water vapor to permeate from a gas to be separated containing at least hydrogen, water vapor, and a third gas by using the composite separation structure according to any one of [1] to [13].

[21] The separation or concentration method according to any one of to [20], in which a pressure on a permeation side where hydrogen permeates and a hydrogen concentration increases is reduced.

[22] The separation or concentration method according to any one of to [21], in which a hydrogen concentration on a permeation side where hydrogen permeates and a hydrogen concentration increases is 96% or more, and a hydrogen recovery rate defined by a ratio of an amount of hydrogen on the permeation side to an amount of hydrogen contained in the gas to be separated is 80% or more.

[23] A separation or concentration method comprising: allowing hydrogen to permeate from a gas to be separated containing at least hydrogen and carbon dioxide by using the composite separation structure according to any one of [1] to [13].

[24] A composite separation structure comprising a substrate section, a first separation section disposed in contact with the substrate section, and a second separation section having an amorphous structure and disposed not in contact with the substrate section but in contact with the first separation section, in which the second separation section contains a Si atom, and the Si atom is an atom supplied in a vapor phase.

[25] A composite separation structure including a substrate section, a first separation section disposed in contact with the substrate section, and a second separation section having an amorphous structure and disposed not in contact with the substrate section but in contact with the first separation section, in which hydrogen detonating gas having a hydrogen-to-oxygen ratio of 2 and a pressure of 0.2 MPa(G) or less is separated such that a ratio α (H₂/O₂) of hydrogen permeance to oxygen permeance is 10 or more and 110 or less.

[26] The composite separation structure according to any one of [1] to [4], in which a ratio of variance in density of the second separation section to that of the first separation section is 0.001 or more and 0.08 or less.

[27] The composite separation structure according to any one of [1] to [4], in which a high-density region is provided in a part of the second separation section, and a ratio of the high-density region to the second separation section is 0.02 or more and 0.1 or less.

### Advantageous Effects of Invention

According to the present invention, it is possible to provide a composite separation structure capable of separating gases having various small kinetic diameters (kinetic diameters) with high separability, and particularly capable of realizing the separation or concentration of a gas mixture containing a gas having a kinetic diameter of 4 Å or less, and a method for producing the composite separation structure.

By using the composite separation structure of the present invention, it is possible to increase the difference in permeability between a component having high permeability and a component having low permeability from a gas composed of a plurality of components, and in particular, even in a gas containing a component having a kinetic diameter (kinetic diameter) of 4 Å or less in at least one of the components, it is possible to separate a component having high permeability or concentrate a component having low permeability by allowing a component having high permeability to permeate with high separation performance. Further, it is possible to effectively perform the above-described separation and concentration even under conditions of the presence of water vapor.

### BRIEF DESCRIPTION OF DRAWINGS

FIG. 1 is a schematic view of a composite separation structure of the present invention.

FIG. 2 is a schematic view of a gas flow apparatus used for forming a second separation section.

FIG. 3 is a schematic view of the inside of a reaction tube of the gas flow apparatus used for forming the second separation section.

FIG. 4 is a schematic view of a measuring device used for gas separation.

FIG. 5 is a schematic view of a sealed apparatus used for forming the second separation section.

FIG. 6 is a graph showing a change in hydrogen permeance over time.

FIG. 7 is a graph showing a change in the ratio of hydrogen permeance to oxygen permeance over time.

### DESCRIPTION OF EMBODIMENTS

Hereinafter, the embodiments of the present invention will be described in more detail, but the description of the constituent elements described below is an example of the embodiments of the present invention, and the present invention is not limited to these contents, and can be implemented with various modifications within the scope of the gist thereof.

### [Composite Separation Structure]

The shape of the composite separation structure of the present invention is not particularly limited as long as the composite separation structure has a substrate section, a first separation section disposed in contact with the substrate section, and a second separation section disposed not in contact with the substrate section but in contact with the first separation section. For example, a sheet-shaped laminate in which a first separation section and a second separation section are laminated in this order on a sheet-shaped substrate section may be used. In the case of such a sheet-shaped laminate, the gas to be separated and concentrated (hereinafter, also referred to as “gas to be separated”) is allowed to permeate from the second separation section side, and a specific gas of the gas to be separated and concentrated is concentrated, allowed to permeate, and separated in the process of permeating the second separation section and the first separation section in this order.

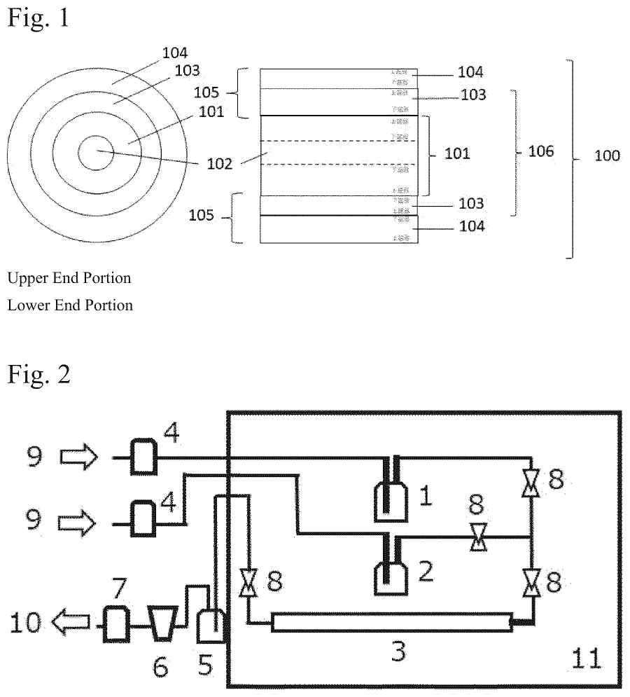

In addition, as shown in FIG. 1, a structure in which the substrate section, the first separation section, and the second separation section are concentrically laminated in a cylindrical shape may be used. Such a cylindrical structure is preferable because the gas to be separated and concentrated can be efficiently concentrated and separated even in a small space.

Hereinafter, a cylindrical composite separation structure as shown in FIG. 1 will be described in detail.

The composite separation structure 100 of the present invention includes a substrate section 101, a first separation section 103 disposed in contact with the substrate section, and a second separation section 104 disposed not in contact with the substrate section but in contact with the first separation section. The substrate section 101 preferably has a void section 102 for recovering the target gas from the gas to be separated and concentrated in the composite separation structure. That is, the gas to be separated and concentrated is introduced from the outside of the second separation section 104, is concentrated and separated in a process in which the gas permeates through the second separation section and the first separation section, and the target gas is recovered from the void section 102.

In the embodiment shown in FIG. 1, the composite separation structure of the present invention has a substrate section 101 at the center, a first separation section 103 disposed on the outer side of the substrate section 101 in contact therewith, and a second separation section 104 disposed on the further outer side of the first separation section in contact therewith. Here, a face of the substrate section 101 in contact with the first separation section may be referred to as an “upper end portion”, and a side opposite to the upper end portion, that is, a side where the void 102 is provided may be referred to as a “lower end portion”. Further, an end portion of the first separation section 103 in contact with the second separation section 104 may be referred to as an “upper end portion”, and an end portion in contact with the substrate section 101 may be referred to as a “lower end portion”. Also, an end portion of the second separation section 104 in contact with the first separation section 103 may be referred to as a “lower end portion”, and an end portion on the opposite side may be referred to as an “upper end portion”.

In the cylindrical composite separation structure, a first separation section may be formed inside the substrate section, and a second separation section may be formed further inside the first separation section. Also in this case, the face of the substrate section in contact with the first separation section is defined as the “upper end portion”, and the opposite side, that is, the outer face is defined as the “lower end portion”. In addition, an end portion of the first separation section in contact with the second separation section is defined as an “upper end portion”, an end portion in contact with the substrate section is defined as a “lower end portion”, an end portion of the second separation section in contact with the first separation section is defined as a “lower end portion”, and an opposite end portion, that is, a void side is defined as an “upper end portion”.

In this aspect, the gas to be separated and concentrated is introduced from the inner surface side of the composite separation structure, that is, the central void section, and is concentrated and separated in the process of permeation of the gas through the second separation section and the first separation section, and the target gas is taken out from the outer surface side.

### First Invention

As a first invention of the present application, in the above-described composite separation structure, the second separation section has an amorphous structure. More specifically, the composite separation structure is a composite separation structure in which a simple substance separation structure (composed of a substrate section and a first separation section) made of a thin film body of, for example, a zeolite polycrystal is provided on a substrate section such as a porous substrate by, for example, crystal growth, and an upper end portion of the simple substance separation structure is treated with, for example, gas derived from a Si compound and water vapor derived from water to form an amorphous layer (second separation section) on the simple substance separation structure. Here, a composite separation structure having a desired permeation separation performance can be obtained by controlling factors relating to the production, such as the conditions of the treatment time in the production, and such a production method is also included in the first invention of the present application. Further, a method for separating or concentrating a gas in which a mixed gas (gas to be separated) containing a plurality of gas components is brought into contact with the composite separation structure, and a component having high permeability in the mixed gas is allowed to permeate to separate the component having high permeability from the mixed gas, or a component having low permeability is concentrated by allowing the component having high permeability to permeate from the mixed gas is also included in the first invention of the present application.

Hereinafter, a composite separation structure having a substrate section, a first separation section disposed in contact with the substrate section, and a second separation section disposed not in contact with the substrate section but in contact with the first separation section, which is a characteristic of the present invention, will be described.

In addition, the relationship between the structures of the “first separation section”, the “second separation section”, and the “substrate section” in the description herein is shown in FIG. 1. Further, the composite of the “substrate section” and the “first separation section” is referred to as a “simple substance separation structure”.

### <Substrate Section>

In the present invention, the substrate section is not particularly limited as long as it can form the first separation section at the upper end portion thereof, but it is preferably chemically stable in forming the first separation section. Further, it is preferable that the substrate section has mechanical strength in the separation step. In this respect, ceramics, ceramic sintered bodies, metals, metal sintered bodies and various insulators can be exemplified, and inorganic porous materials are preferable.

In particular, when the first separation section is zeolite having various structures, the substrate section is preferably an inorganic porous material. In addition, the substrate section may be composed of a plurality of inorganic porous materials having different pore diameters. When the first separation section is zeolite, as the substrate section, for example, a ceramic sintered body such as silica, α-alumina, γ-alumina, mullite, zirconia, titania, yttria, silicon nitride, or silicon carbide is preferable. Among these, an inorganic porous substrate section containing at least one of alumina, silica and mullite is preferable. When these inorganic porous substrate sections are used, since their partial zeolitization is easy, the bonding between the substrate section and zeolite becomes strong, and a dense membrane having high separation performance is easily formed.

The shape of the inorganic porous substrate section is not particularly limited as long as it can effectively separate a gas mixture (gas to be separated), and specific examples thereof include a flat plate shape, a tubular shape, a honeycomb shape having a large number of cylindrical, columnar or prismatic holes, and a monolith. In the present invention, it is preferable to form zeolite in the form of a membrane on the inorganic porous substrate section, that is, on the upper end portion of the substrate section. The upper end portion of the inorganic porous substrate section is defined as a face forming the first separation section as described above, and means a surface portion of the inorganic porous substrate section where zeolite is crystallized. The surface may be any surface of each shape as long as it is a surface, and may be a plurality of surfaces. For example, in the case of the substrate section of a cylindrical tube, the upper end portion may be the outer surface or the inner surface, or in some cases both the outer and inner surfaces. In this case, either surface is defined as an upper end portion.

The average pore diameter of the upper end portion of the inorganic porous substrate section is not particularly limited, but it is preferable that the pore diameter is controlled. The average pore diameter of the upper end portion of the inorganic porous substrate section is usually 0.02 μm or more, preferably 0.05 μm or more, and more preferably 0.1 μm or more, and is usually 20 μm or less, preferably 10 μm or less, and more preferably 5 μm or less. When the average pore diameter is 0.02 μm or more, a sufficient permeation amount can be obtained, and when the average pore diameter is 20 μm or less, the strength of the substrate section itself becomes sufficient. In addition, the proportion of the pores at the upper end portion of the inorganic porous substrate section is appropriate, and a sufficiently dense zeolite simple substance separation structure is formed. The average pore diameter of the substrate section from the lower end portion to the upper end portion can be changed depending on the purpose. In particular, in the upper end portion of the substrate section where the first separation section is intended to be formed, it is also preferable to make the average pore diameter smaller than that of other portions of the substrate section in order to obtain a dense zeolite simple substance separation structure.

The average thickness (wall thickness) of the inorganic porous substrate section is usually 0.1 mm or more, preferably 0.3 mm or more, and more preferably 0.5 mm or more, and is usually 7 mm or less, preferably 5 mm or less, and more preferably 3 mm or less. The inorganic porous substrate section is used for the purpose of giving mechanical strength to the simple substance separation structure, and when the average thickness of the inorganic porous substrate section is 0.1 mm or more, the simple substance separation structure has sufficient strength, and the simple substance separation structure becomes strong against impact and vibration. In addition, when the average thickness of the inorganic porous substrate section is 7 mm or less, diffusion of the permeated material becomes favorable, and sufficient permeability is obtained.

The porosity of the inorganic porous substrate section is usually 20% or more, preferably 25% or more, and more preferably 30% or more, and is usually 70% or less, preferably 60% or less, and more preferably 50% or less. The porosity of the inorganic porous substrate section affects the permeation flow rate at the time of gas separation, and when the porosity is 20% or more, sufficient diffusion of the permeate is obtained. On the other hand, when it is 70% or less, sufficient strength of the inorganic porous substrate section can be obtained.

In addition, the upper end portion of the inorganic porous substrate section may be polished by a file as necessary. By polishing with a file, for example, when there is a burr on the surface, the surface can be smoothed, and conversely, by roughening the smooth surface, the subsequent treatment such as supporting crystals and growing crystals can be made more efficient.

### <Simple Substance Separation Structure>

The simple substance separation structure 106 in the present invention is composed of the substrate section 101 and the first separation section 103 (see FIG. 1). The configuration of the first separation section is not particularly limited, and for example, an inorganic porous thin layer composed of ceramics or a silica membrane can be employed, but it is preferable to employ a zeolite polycrystal thin film body in the simple substance separation layer (first separation section). It is preferable to form a polycrystalline thin film body of zeolite on the inorganic porous substrate section by crystal growth to obtain a zeolite simple substance separation structure. In addition to zeolite, an inorganic binder such as silica or alumina, or an organic compound such as a polymer may be contained as a component constituting the zeolite simple substance separation structure, if necessary. Further, the zeolite simple substance separation structure before the upper end portion treatment in the present invention may partially contain an amorphous component, but a zeolite simple substance separation structure substantially composed of only zeolite is preferable.

The thickness of the first separation section composed of zeolite is not particularly limited, but is usually 0.1 μm or more, preferably 0.6 μm or more, and more preferably 1.0 μm or more, and is usually 100 μm or less, preferably 60 μm or less, and more preferably 20 μm or less. When the membrane thickness is 100 μm or less, a sufficient permeation amount can be obtained, and when the membrane thickness is 0.1 μm or more, the selectivity of a gas to be permeated is improved, and a sufficient membrane strength can be obtained.

The particle diameter of the zeolite is not particularly limited, but is usually preferably 30 nm or more, more preferably 50 nm or more, and still more preferably 100 nm or more, and the upper limit is the membrane thickness or less. When the particle diameter of the zeolite is 30 nm or more, the particle boundary does not become large and sufficient permeation selectivity can be obtained. Therefore, it is particularly preferable that the particle diameter of the zeolite is the same as the thickness of the membrane. When the particle diameter of the zeolite is the same as the thickness of the membrane, the particle boundary of the zeolite is the smallest. The zeolite simple substance separation structure obtained by the hydrothermal synthesis described later is particularly preferable because the particle diameter of the zeolite and the thickness of the membrane tend to be the same.

The shape of the zeolite simple substance separation structure is not particularly limited, and any shape such as a tubular shape, a hollow filament shape, a monolith shape, and a honeycomb shape can be adopted. Further, the size is also not particularly limited, and for example, in the case of a tubular shape, it is practical and preferable that a length is usually 2 cm or more and 200 cm or less, an inner diameter is 0.05 cm or more and 2 cm or less, and a thickness is 0.5 mm or more and 4 mm or less. One of the separation functions of the zeolite simple substance separation structure is separation as a molecular sieve, and gas molecules having a size equal to or larger than the effective pore diameter of the zeolite to be used can be suitably separated from gases having a size smaller than the effective pore diameter. There is no upper limit on the molecules to be separated, but the size of the molecules is usually about 100 Å or less.

The type of the main zeolite constituting the zeolite simple substance separation structure is not particularly limited. All zeolite structure types defined by the International Zeolite Association are included. The zeolite is more preferably a zeolite having a pore structure of a 12-membered or less oxygen ring, still more preferably a zeolite having a pore structure of an 8-membered or less oxygen ring, and may be a zeolite having a pore structure of a 6-membered oxygen ring. A pore having a smaller oxygen membered ring has a higher effect of narrowing the pore by the modification reaction, and the molecular sieve effect is more likely to occur.

In the present invention, the zeolite is particularly preferably a zeolite having a 6-membered oxygen ring or 8-membered oxygen ring structure.

The value of n of the zeolite having a n-membered oxygen ring referred to herein indicates that the number of oxygen atoms is the largest in the pores composed of oxygen and a T element (an element other than oxygen constituting the framework) forming the zeolite framework. For example, when pores of a 12-membered oxygen ring and an 8-membered oxygen ring are present as in the MOR type zeolite, the zeolite is regarded as a zeolite having a 12-membered oxygen ring.

For example, the zeolite having a pore structure of an 8-membered or less oxygen ring include AEI, AFG, AFX, ANA, BRE, CAS, CDO, CHA, DDR, DOH, EAB, EPI, ERI, ESV, FAR, FRA, GIS, GIU, GOO, ITE, KFI, LEV, LIO, LOS, LTN, MAR, MEP, MER, MEL, MON, MSO, MTF, MTN, MWF, NON, PAU, PHI, RHO, RTE, RTH, RUT, SGT, SOD, TOL, TSC, UFI, VNI, YUG and so on.

For example, the zeolite having a 6- to 8-membered oxygen ring structure include AEI, AFG, AFX, ANA, CHA, EAB, ERI, ESV, FAR, FRA, GIS, ITE, KFI, LEV, LIO, LOS, LTN, MAR, MWF, PAU, RHO, RTH, SOD, TOL, UFI and so on.

In the description herein, as described above, the structure of zeolite is indicated by a code defining the structure of zeolite defined by the International Zeolite Association (IZA).

The n-membered oxygen ring structure determines the size of the pore of the zeolite, and in a zeolite having a pore size smaller than that of a 6-membered oxygen ring, the pore diameter becomes smaller than the kinetic diameter of H₂O molecules, and hence the permeability becomes small, which may be impractical. In addition, in the case of a zeolite larger than the 8-membered oxygen ring structure, the pore diameter is increased, and in the case of a gas component having a small size, the separation performance is reduced in some cases, and thus the use is limited in some cases.

The framework density (T/1000 Å) of the zeolite is not particularly limited, but is usually 17 or less, preferably 16 or less, more preferably 15.5 or less, and particularly preferably 15 or less, and is usually 10 or more, preferably 11 or more, and more preferably 12 or more.

The framework density means the number of elements (T elements) other than oxygen constituting the framework per 1000 Å of the zeolite, and this value is determined by the structure of the zeolite. The relationship between the framework density and the structure of the zeolite is shown in ATLAS OF ZEOLITE FRAMEWORK TYPES Fifth Revised Edition (2001) ELSEVIER.

In the present invention, preferred zeolite structures are AEI, AFG, AFX, CHA, EAB, ERI, ESV, FAR, FRA, GIS, ITE, KFI, LEV, LIO, LOS, LTN, MAR, MWF, PAU, RHO, RTH, SOD, TOL and UFI, more preferred structures are AEI, CHA, ERI, KFI, LEV, RHO, RTH and UFI, still more preferred structures are CHA and ERI, and the most preferred structure is CHA.

Here, in the present invention, the CHA-type zeolite refers to a zeolite having a CHA structure as defined by the code defining the structure of zeolite defined by the International Zeolite Association (IZA). This is a zeolite having a crystal structure equivalent to that of naturally occurring chabazite. The CHA-type zeolite has a structure characterized by having three dimensional pores composed of 8-membered oxygen rings having a diameter of 3.8×3.8 Å, and the structure is characterized by X-ray diffraction data.

The framework density (T/1000 Å) of the CHA-type zeolite is 14.5.

In the present invention, when the zeolite simple substance separation structure contains a CHA-type zeolite, in the X-ray diffraction pattern of the zeolite simple substance separation structure, the intensity of the peak in the vicinity of 2θ=17.9° is preferably 0.5 or more of the intensity of the peak in the vicinity of 2θ=20.8°.

Here, the intensity of the peak refers to a value obtained by subtracting a background value from a measured value. The peak intensity ratio represented by (the intensity of the peak in the vicinity of 2θ=17.9°)/(the intensity of the peak in the vicinity of 2θ=20.8°) (hereinafter, this may be referred to as a “peak intensity ratio A”) is usually 0.5 or more, preferably 1 or more, more preferably 1.2 or more, and particularly preferably 1.5 or more. The upper limit is not particularly limited, but is usually 1,000 or less.

In addition, when the zeolite simple substance separation structure contains a CHA-type zeolite, in the X-ray diffraction pattern, the intensity of the peak in the vicinity of 2θ=9.6° is preferably twice or more the intensity of the peak in the vicinity of 2θ=20.8°.

The peak intensity ratio represented by (the intensity of the peak in the vicinity of 2θ=9.6°)/(the intensity of the peak in the vicinity of 2θ=20.8°) (hereinafter, this may be referred to as a “peak intensity ratio B”) is usually 2 or more, preferably 2.5 or more, more preferably 3 or more, still more preferably 4 or more, even more preferably 6 or more, particularly preferably 8 or more, and most preferably 10 or more. The upper limit is not particularly limited, but is usually 1,000 or less.

The X-ray diffraction pattern referred to herein is obtained by irradiating the surface on which zeolite is mainly adhered with X-rays using CuKα as a radiation source and setting the scanning axis to θ/2θ. The shape of the sample to be measured is not particularly limited as long as the surface of the simple substance separation structure on which zeolite is mainly adhered can be irradiated with X-rays. As a sample that well represents the characteristics of the simple substance separation structure, it is preferable to use the simple substance separation structure as it is or to use a sample cut to an appropriate size that is limited depending on an apparatus.

Here, in the case where the upper end portion of the zeolite simple substance separation structure has a curved surface, the X-ray diffraction pattern may be measured by using an automatic variable slit and fixing the radiation width. The X-ray diffraction pattern in the case where the automatic variable slit is used refers to a pattern in which the fixed slit correction is performed from the variable slit.

Here, the peak in the vicinity of 2θ=17.9° refers to a maximum peak among peaks present in a range of 17.9°±0.6° among peaks not derived from the base material.

The peak in the vicinity of 2θ=20.8° refers to a maximum peak among peaks present in a range of 20.8°±0.6° among peaks not derived from the base material.

The peak in the vicinity of 2θ=9.6° refers to a maximum peak among peaks present in a range of 9.6°±0.6° among peaks not derived from the base material.

According to COLLECTION OF SIMULATED XRD POWDER PATTERNS FOR ZEOLITE Third Revised Edition (1996), ELSEVIER (NPL 4), the peak in the vicinity of 2θ=9.6° in the X-ray diffraction pattern is a peak derived from a plane having an index of (1, 0, 0) in the CHA structure when the space group is

Rθ̅m

(No. 166) in the rhombohedral setting.

Further, according to NPL 4, the peak in the vicinity of 2θ=17.9° in the X-ray diffraction pattern is a peak derived from a plane having an index of (1, 1, 1) in the CHA structure when the space group is

Rθ̅m

(No. 166) in the rhombohedral setting.

According to NPL 4, the peak in the vicinity of 2θ=20.8° in the X-ray diffraction pattern is a peak derived from a plane having an index of (2, 0, −1) in the CHA structure when the space group is

Rθ̅m

(No. 166) in the rhombohedral setting.

According to Halil Kalipcilar et al., “Synthesis and Separation Performance of SSZ-13 Zeolite Membranes on Tubular Supports”, Chem. Matter. (2002), 14, 3458-3464 (NPL 5), a typical ratio (peak intensity ratio B) of the peak intensity derived from the (2, 0, −1) plane to the peak intensity derived from the (1, 0, 0) plane in the zeolite simple substance separation structure of the CHA-type aluminosilicate is less than 2.

Therefore, it is considered that the fact that this ratio is 2 or more means that the zeolite crystals are oriented and grown so that, for example, the (1, 0, 0) plane in the case where the CHA structure is a rhombohedral setting is oriented close to parallel to the upper end portion of the simple substance separation structure. The fact that the zeolite crystals are oriented and grown in the zeolite simple substance separation structure is advantageous in that a dense membrane having high separation performance can be formed.

According to NPL 4, a typical ratio (peak intensity ratio A) of the intensity of a peak derived from a (1, 1, 1) plane to the intensity of a peak derived from a (2, 0, −1) plane in a zeolite simple substance separation structure of a CHA-type aluminosilicate is less than 0.5.

Therefore, it is considered that the fact that this ratio is 0.5 or more means that the zeolite crystals are oriented and grown so that, for example, the (1, 1, 1) plane in the case where the CHA structure is a rhombohedral setting is oriented close to parallel to the upper end portion of the simple substance separation structure. The fact that the zeolite crystals are oriented and grown in the zeolite simple substance separation structure is advantageous in that a dense membrane having high separation performance can be formed.

Thus, the fact that either of the peak intensity ratios A and B is a value in the above-mentioned specific range indicates that zeolite crystals are oriented and grown to form a dense membrane having high separation performance.

The larger the values of the peak intensity ratios A and B, the stronger the degree of orientation, and in general, the stronger the degree of orientation, the denser the membrane is formed. Generally, the stronger the orientation, the higher the separation performance tends to be, but the optimum degree of the orientation at which the separation performance is high varies depending on the mixture to be separated (gas to be separated), and therefore it is desirable to select and use a zeolite simple substance separation structure having an optimum degree of the orientation depending on the mixture to be separated.

### <Method for Producing Simple Substance Separation Structure>

The method for producing a simple substance separation structure is not particularly limited as long as the method can form the first separation section on the substrate section. Hereinafter, the method for producing a simple substance separation structure will be described in detail by taking the case where the first separation section is zeolite as an example.

In the present invention, the method for producing the zeolite simple substance separation structure is not particularly limited, but for example, a method of forming zeolite on an inorganic porous substrate section by hydrothermal synthesis is preferable.

In particular, for example, a zeolite simple substance separation structure can be prepared by putting a reaction mixture for hydrothermal synthesis (hereinafter, sometimes referred to as an “aqueous reaction mixture”), which is homogenized by adjusting the composition, into a heat-resistant and pressure-resistant container such as an autoclave in which an inorganic porous substrate section is gently fixed to the inside thereof, sealing the container, and heating the container for a certain period of time.

The aqueous reaction mixture contains a Si element source, an Al element source, an alkali source and water, and may further contain an organic template as necessary.

As the Si element source used in the aqueous reaction mixture, for example, amorphous silica, colloidal silica, silica gel, sodium silicate, amorphous aluminosilicate gel, tetraethoxysilane (TEOS), trimethylethoxysilane and the like can be used.

As the Al element source, for example, sodium aluminate, aluminum hydroxide, aluminum sulfate, aluminum nitrate, aluminum oxide, amorphous aluminosilicate gel and the like can be used. In addition to the Al element source, other element sources, for example, element sources such as Ga, Fe, B, Ti, Zr, Sn and Zn may be contained.

In the crystallization of zeolite, an organic template (structure-directing agent) can be used as necessary, and one synthesized using an organic template is preferable. By performing synthesis using an organic template, the ratio of silicon atoms to aluminum atoms in the crystallized zeolite is increased, and acid resistance and water vapor resistance are improved.

The organic template may be of any type as long as it can form a desired zeolite simple substance separation structure, and may be any type. In addition, one type of template or a combination of two or more types of templates may be used.

When the zeolite is a CHA-type zeolite, an amine or a quaternary ammonium salt is usually used as the organic template. For example, organic templates described in U.S. Pat. No. 4,544,538 and U.S. Patent Publication No. 2008/0075656 are preferably used.

Specific examples of the organic template include a cation derived from an alicyclic amine such as a cation derived from 1-adamantanamine, a cation derived from 3-quinuclidinol and a cation derived from 3-exo-aminonorbornene. Among these, a cation derived from 1-adamantanamine is more preferable. When a cation derived from 1-adamantanamine is used as an organic template, a CHA-type zeolite capable of forming a dense membrane is crystallized. By forming a dense membrane, a CHA-type zeolite having high separation performance can be obtained.

Of the cations derived from 1-adamantanamine, N,N,N-trialkyl-1-adamantanammonium cations are more preferred. The three alkyl groups of the N,N,N-trialkyl-1-adamantanammonium cation are usually each independently an alkyl group, preferably a lower alkyl group, and more preferably a methyl group. The most preferred compound among them is N,N,N-trimethyl-1-adamantanammonium cation.

Such cations are accompanied by anions which do not adversely affect the formation of the CHA-type zeolite. Representative of such anions include halogen ions such as Cl⁻, Br⁻ and I⁻, hydroxide ions, sulfate radicals and carboxylic acid radicals such as acetate radicals. Among these, hydroxide ions are particularly suitably used.

As other organic templates, N,N,N-trialkylbenzylammonium cations can also be used. Also in this case, the alkyl groups are each independently an alkyl group, preferably a lower alkyl group, and more preferably a methyl group. Among them, the most preferable compound is N,N,N-trimethylbenzylammonium cation. Anions that accompany these cations are the same as described above.

As the alkali source used in the aqueous reaction mixture, hydroxide ions of the counter anion of the organic template, alkali metal hydroxides such as NaOH and KOH and alkaline-earth metal hydroxides such as Ca(OH)₂ can be used. The kind of the alkali is not particularly limited, and Na, K, Li, Rb, Cs, Ca, Mg, Sr and Ba are usually used. Among these, Li, Na and K are preferable, and K is more preferable. In addition, two or more kinds of alkalis may be used in combination, and specifically, Na and K, and Li and K are preferably used in combination.

The ratio of the Si element source to the Al element source in the aqueous reaction mixture is usually expressed as the molar ratio of the oxides of the respective elements, i.e., the SiO₂/Al₂O₃ molar ratio. The SiO₂/Al₂O₃ molar ratio is not particularly limited, but is usually 5 or more, preferably 8 or more, more preferably 10 or more, and still more preferably 15 or more. On the other hand, the SiO₂/Al₂O₃ molar ratio is usually 10,000 or less, preferably 1,000 or less, more preferably 300 or less, and still more preferably 100 or less.

When the SiO₂/Al₂O₃ molar ratio is within this range, the zeolite simple substance separation structure is densely formed, and a membrane having a high separation performance is obtained. Furthermore, since an appropriate amount of Al atoms are present in the formed zeolite, the separation capacity is improved in the case of a gas component that exhibits adsorptivity with respect to Al. In addition, when Al atoms are included in this range, a zeolite simple substance separation structure having high acid resistance and high water vapor resistance can be obtained.

The ratio of the silica source to the organic template in the aqueous reaction mixture, i.e., the molar ratio of the organic template to SiO₂ (organic template/SiO₂ molar ratio), is usually 0.005 or more, preferably 0.01 or more, and more preferably 0.02 or more, and is usually 1 or less, preferably 0.4 or less, and more preferably 0.2 or less.

When the organic template/SiO₂ (molar ratio) is within the above range, a dense zeolite simple substance separation structure can be produced, and the produced zeolite becomes strong against acid resistance and water vapor resistance.

The ratio of the Si element source to the alkali source in terms of M_{(2/n)}O/SiO₂ (in which M represents an alkali metal or an alkaline earth metal, and n represents a valence 1 or 2) molar ratio is usually 0.02 or more, preferably 0.04 or more, and more preferably 0.05 or more, and is usually 0.5 or less, preferably 0.4 or less, and more preferably 0.3 or less.

In the case of forming the CHA-type zeolite simple substance separation structure, it is preferable to contain K in the alkali metal from the viewpoint of forming a denser membrane having high crystallinity. In this case, the molar ratio of K to all alkali metals including K and/or alkaline earth metals is usually 0.01 or more and 1 or less, preferably 0.1 or more and 1 or less, and more preferably 0.3 or more and 1 or less.

As described above, when the space group is (No. 166) in the rhombohedral setting,

Rθ̅m
the addition of K to the aqueous reaction mixture tends to increase the ratio (peak intensity ratio B) of the peak intensity in the vicinity of 2θ=9.6° which is a peak derived from the (1, 0, 0) plane in the CHA structure to the peak intensity in the vicinity of 2θ=20.8° which is a peak derived from the (2, 0, −1) plane, or the ratio (peak intensity ratio A) of the peak intensity in the vicinity of 2θ=17.9° which is a peak derived from the (1, 1, 1) plane to the peak intensity in the vicinity of 2θ=20.8° which is a peak derived from the (2, 0, −1) plane.

The ratio of the Si element source and water is usually 10 or more, preferably 30 or more, more preferably 40 or more, and particularly preferably 50 or more, and is usually 1,000 or less, preferably 500 or less, more preferably 200 or less, and particularly preferably 150 or less, in terms of the molar ratio of water to SiO₂ (H₂O/SiO₂ (molar ratio)).

When the molar ratio of the substances in the aqueous reaction mixture is within these ranges, a dense zeolite simple substance separation structure can be produced. The amount of water is particularly important in the production of a dense zeolite simple substance separation structure, and a dense membrane tends to be formed more easily under the condition that water is more abundant relative to silica than under general conditions of powder synthesis methods.

In general, the amount of water at the time of synthesizing a powdery CHA-type zeolite is about 15 to 50 in terms of H₂O/SiO₂ (molar ratio). By setting the H₂O/SiO₂ (molar ratio) to be high (50 or more and 1000 or less), that is, under conditions in which the amount of water is large, it is possible to obtain a zeolite simple substance separation structure having high separation performance in which the CHA-type zeolite is crystallized in the form of a dense membrane on the inorganic porous substrate section.

Further, in the hydrothermal synthesis, it is not always necessary to allow a seed crystal to be present in the reaction system, but addition of a seed crystal can promote crystallization of zeolite on the inorganic porous substrate section. The method for adding a seed crystal is not particularly limited, and it is possible to use a method in which a seed crystal is added to the aqueous reaction mixture as in the synthesis of a powdered zeolite or a method in which a seed crystal is attached to the inorganic porous substrate section.

In a case where the zeolite simple substance separation structure is produced, it is preferable that the seed crystal is attached to the inorganic porous substrate section. By attaching the seed crystal to the inorganic porous substrate section in advance, a zeolite simple substance separation structure that is dense and has good separation performance is easily produced.

The seed crystal to be used may be of any type as long as it is a zeolite that promotes crystallization, but is preferably of the same crystalline type as the zeolite simple substance separation structure to be formed in order to efficiently crystallize the zeolite. In the case of forming a CHA-type zeolite simple substance separation structure, it is preferable to use a seed crystal of a CHA-type zeolite.

The particle diameter of the seed crystal is usually 0.5 nm or more, preferably 1 nm or more, and more preferably 2 nm or more, and is usually 20 μm or less, preferably 15 μm or less, and more preferably 10 μm or less.

The method for attaching the seed crystal to the inorganic porous substrate section is not particularly limited, and for example, a dip method in which the seed crystal is dispersed in a solvent such as water and the substrate section is immersed in the dispersion liquid to attach the seed crystal, or a method in which a slurry of the seed crystal mixed with a solvent such as water is applied to the inorganic porous substrate section can be used. The dip method is desirable for controlling the amount of the seed crystal to be attached and producing the zeolite simple substance separation structure with good reproducibility.

The solvent in which the seed crystal is dispersed is not particularly limited, but water is particularly preferable. The amount of the seed crystal to be dispersed is not particularly limited, but is usually 0.01% by mass or more, preferably 0.1% by mass or more, and more preferably 0.3% by mass or more, and is usually 20% by mass or less, preferably 10% by mass or less, more preferably 5% by mass or less, still more preferably 4% by mass or less, and particularly preferably 3% by mass or less, with respect to the total mass of the dispersion liquid.

In a case where the amount of the seed crystal to be dispersed is equal to or greater than the above-described lower limit value, the amount of the seed crystal attached to the inorganic porous substrate section is sufficient, and thus the seed crystal is formed on the entire substrate section during the hydrothermal synthesis, and there is no place where zeolite is not partially formed, so that it is possible to obtain a membrane having no defects. The amount of the seed crystal attached to the inorganic porous substrate section by the dip method is substantially constant at a certain level or more of the amount of the seed crystal in the dispersion liquid, and thus, in a case where the amount of the seed crystal in the dispersion liquid is equal to or less than the above-described upper limit, there is no waste of the seed crystal, which is advantageous in terms of cost.

It is preferable that the seed crystal is attached to the inorganic porous substrate section by a dip method or by coating with a slurry, and the seed crystal is dried to form a zeolite simple substance separation structure.

The amount of the seed crystal attached to the inorganic porous substrate section in advance is not particularly limited, but is usually 0.01 g or more, preferably 0.05 g or more, and more preferably 0.1 g or more, and is usually 100 g or less, preferably 50 g or less, more preferably 10 g or less, and still more preferably 8 g or less, in terms of mass per 1 m² of the base material.

In a case where the amount of the seed crystal is equal to or greater than the above-described lower limit value, crystals are easily generated, a membrane is sufficiently grown, and the growth of the membrane is easily made uniform. On the other hand, in a case where the amount of the seed crystal is equal to or lower than the above-described upper limit value, the surface irregularities are not increased by the seed crystal, the spontaneous nucleus is not easily grown by the seed crystal dropped from the substrate section, and the membrane growth on the substrate section is not inhibited. Therefore, a dense zeolite simple substance separation structure is easily generated.

When a zeolite simple substance separation structure is formed on an inorganic porous substrate section by hydrothermal synthesis, the method for fixing the inorganic porous substrate section is not particularly limited, and any form such as vertical placement or horizontal placement can be employed. In this case, the zeolite simple substance separation structure may be formed by a static method, or the zeolite simple substance separation structure may be formed by stirring the aqueous reaction mixture.

The temperature for forming the zeolite simple substance separation structure is not particularly limited, but is usually 100° C. or higher, preferably 120° C. or higher, and more preferably 150° C. or higher, and is usually 200° C. or lower, preferably 190° C. or lower, and more preferably 180° C. or lower. When the reaction temperature is equal to or higher than the above lower limit value, the zeolite is easily crystallized, and when the reaction temperature is equal to or lower than the above upper limit value, a zeolite of a type different from the desired zeolite is not generated due to an excessively high reaction temperature.

The heating time is not particularly limited, but is usually 1 hour or more, preferably 5 hours or more, and more preferably 10 hours or more, and is usually 10 days or less, preferably 5 days or less, more preferably 3 days or less, and still more preferably 2 days or less. When the reaction time is equal to or more than the above lower limit value, the zeolite is sufficiently crystallized. On the other hand, when the reaction time is equal to or less than the above upper limit value, a zeolite of a type different from the desired zeolite is not generated.

The pressure at the time of zeolite simple substance separation structure formation is not particularly limited, and the autogenous pressure generated when the aqueous reaction mixture placed in a closed container is heated to this temperature range is sufficient. Further, if necessary, an inert gas such as nitrogen may be added.

The zeolite simple substance separation structure obtained by hydrothermal synthesis is washed with water and then subjected to a heat treatment. Here, the heat treatment means that the zeolite simple substance separation structure is dried by heating, or when a template is used, the template is removed by burning.

The temperature of the heat treatment is usually 50° C. or higher, preferably 80° C. or higher, and more preferably 100° C. or higher, and is usually 200° C. or lower and preferably 150° C. or lower, for the purpose of drying. When the heat treatment is performed for the purpose of removing the template by burning, the temperature of the heat treatment is usually 350° C. or higher, preferably 400° C. or higher, more preferably 430° C. or higher, and still more preferably 480° C. or higher, and is usually 900° C. or lower, preferably 850° C. or lower, more preferably 800° C. or lower, and still more preferably 750° C. or lower.

When the heat treatment is performed for the purpose of removing the template by burning, when the temperature of the heat treatment is equal to or higher than the above lower limit value, the organic template can be sufficiently removed by burning and does not remain, so that the pores of the zeolite become sufficient, and the permeation flux at the time of separation and concentration can be secured. On the other hand, when the heat treatment temperature is equal to or lower than the above upper limit value, the difference in thermal expansion coefficient between the substrate section and zeolite does not become large, and no crack occurs in the zeolite simple substance separation structure. Therefore, sufficient denseness of the zeolite simple substance separation structure can be ensured, and sufficient separation performance can be obtained.

The heating time is not particularly limited as long as the zeolite simple substance separation structure is sufficiently dried or the template is removed by burning, and is preferably 0.5 hours or more and more preferably 1 hour or more. The upper limit is not particularly limited, and is usually 200 hours or less, preferably 150 hours or less, and more preferably 100 hours or less. When the heat treatment is performed for the purpose of removing the template by burning, the heat treatment may be performed in an air atmosphere, but may be performed in an atmosphere to which an inert gas such as N₂, or oxygen is added.

In the case where the hydrothermal synthesis is carried out in the presence of an organic template, it is appropriate to wash the obtained zeolite simple substance separation structure with water and then remove the organic template by, for example, a heat treatment or extraction, or preferably a heat treatment, that is, burning.

When the heat treatment is performed for the purpose of removing the template by burning, it is desirable that the temperature increase rate is as slow as possible in order to reduce the possibility that the difference in thermal expansion coefficient between the substrate section and zeolite causes cracks in the zeolite simple substance separation structure. The temperature increase rate is usually 5° C./min or less, preferably 2° C./min or less, more preferably 1° C./min or less, and particularly preferably 0.5° C./min or less. The temperature increase rate is usually 0.1° C./min or more in consideration of workability.

In addition, the temperature drop rate after burning must also be controlled in order to avoid cracking of the zeolite simple substance separation structure. As with the temperature increase rate, the temperature drop rate is desirably as slow as possible. The temperature drop rate is usually 5° C./min or less, preferably 2° C./min or less, more preferably 1° C./min or less, and particularly preferably 0.5° C./min or less. The temperature increase rate is usually 0.1° C./min or more in consideration of workability.

The zeolite simple substance separation structure may be ion-exchanged as necessary. In the case of synthesis using a template, the ion-exchange is usually performed after the template is removed. Examples of the ion to be ion-exchanged include protons, alkali metal ions such as Na⁺, K⁺ and Li⁺, Group 2 element ions such as Ca²⁺, Mg²⁺, Sr²⁺ and Ba²⁺, and transition metal ions such as Fe, Cu and Zn. Among these, protons and alkali metal ions such as Na⁺, K⁺ and Li⁺ are preferable.

The ion-exchange may be carried out by treating the zeolite simple substance separation structure after burning (when a template is used) with an aqueous solution containing an ammonium salt such as NH₄NO₃ and NaNO₃ or an ion to be exchanged, or in some cases, with an acid such as hydrochloric acid, usually at a temperature of from room temperature to 100° C., followed by washing with water. Further, it may be burned at 200° C. to 500° C. as necessary.

The air permeation amount [L/(m²·h)] of the zeolite simple substance separation structure thus obtained (zeolite simple substance separation structure after heat treatment) is usually 1400 L/(m²·h) or less, preferably 1000 L/(m²·h) or less, more preferably 700 L/(m²·h) or less, still more preferably 600 L/(m²·h) or less, even more preferably 500 L/(m²·h) or less, particularly preferably 300 L/(m²·h) or less, and most preferably 200 L/(m²·h) or less. The lower limit of the permeation amount is not particularly limited, but is usually 0.01 L/(m²·h) or more, preferably 0.1 L/(m²·h) or more, and more preferably 1 L/(m²·h) or more.

### <Second Separation Section>

The material of the second separation section formed at the upper end portion of the first separation section is not particularly limited, but it is necessary that the material exhibits a separation performance higher than the gas separation performance of the first separation section. For example, in order to exhibit high separation performance, it is preferable that the material has a smaller pore size than the first separation section (layer) or a material having a higher density. Specifically, the main constituent elements of the material are preferably Si and O, and the material is particularly preferably silica.

In the first invention of the present application, as described above, an amorphous layer having smaller pores is formed in the upper end portion of the simple substance separation structure (for example, a zeolite simple substance separation structure), thereby obtaining a separation performance that cannot be exhibited by the function of the zeolite pore size. In the first invention of the present application, the density of the amorphous layer of the composite separation structure is preferably higher than that of the underlying zeolite. When the ratio of the density of the amorphous layer to the density of the underlying zeolite is defined as a relative density, if the relative density is too low, there is a possibility that the separation performance of the amorphous layer may not be different from that of the zeolite, and practical separation performance cannot be obtained.

On the other hand, if the relative density is too high, the voidage of the amorphous layer will be excessively low, the pores will be excessively narrowed, the permeation resistance will increase, and the permeance of the expected permeation components will decrease. When a known amorphous silica (density=2.2 g/cm³, NPL 6) and a CHA-type zeolite simple substance separation structure are assumed, the relative density is 1.46. On the other hand, considering the low permeation performance reported as an amorphous silica separation membrane, the relative density of 1.46 is considered to be the upper limit. Therefore, the relative density is 1.46 or less, preferably 1.30 or less, and more preferably 1.15 or less.

The second separation section preferably contains Si atoms, and in particular, the Si atoms are preferably atoms supplied in a vapor phase. The vapor phase is advantageous in that Si can be supplied to the upper end portion of the first separation section with higher reactivity, and the desired separation performance can be more sufficiently exhibited. The method for supplying in a vapor phase is not particularly limited, and for example, a liquid Si compound such as a silicate oligomer can be supplied using a bubbler.

### Second Invention

In the second invention of the present application, a thickness of the second separation section is an important factor. Therefore, the second invention of the present application is the above-mentioned composite separation structure, and is characterized in that the thickness of the second separation section from the end portion (lower end portion) in contact with the first separation section to the opposite end portion (upper end portion) (thickness of the second separation section) is 5 nm or more and 200 nm or less.

In order to exhibit practical permeation performance, the second separation section needs to be formed appropriately thick. According to the study by the present inventors, the second separation section is preferably in the form of a membrane, and the lower limit of the thickness thereof is preferably 5 nm or more, more preferably 7 nm or more, still more preferably 10 nm or more, and most preferably 12 nm or more. On the other hand, the second separation section needs to be thinner than a certain thickness so that the gas permeation resistance does not become excessive, and the upper limit of the thickness is 200 nm or less, preferably 100 nm or less, more preferably 50 nm or less, and most preferably 25 nm or less.

In addition, if the first separation section is a porous ceramic or zeolite, it is preferable that the second separation section should be adjustable thickness and a different type of structure with high density. For example, an amorphous structure is preferred. It is also preferable to be a different type of material with a high density, e.g., silica. Therefore, it is more preferable to be amorphous silica having the above-described membrane thickness.

As described above, the second separation section is most preferably a silica membrane having a membrane thickness of 5 nm or more and 200 nm or less.

### Third Invention of the Present Application

The third invention of the present application is characterized in that, in the above-mentioned composite separation structure, the relative density of the second separation section with respect to the first separation section is 1.05 or more and 1.30 or less. When the relative density is 1.05 or more, high separation performance is obtained as described above. On the other hand, when the relative density is 1.30 or less, the pores are not too narrowed, and the permeation resistance is maintained.

From the above viewpoint, the relative density of the second separation section with respect to the first separation section is more preferably 1.11 or more and 1.15 or less.

### Fourth Invention of the Present Application

The fourth invention of the present application is characterized in that in the above-mentioned composite separation structure, the absolute density of the second separation section is 1.58 g/cm³ or more and 1.96 g/cm³ or less. When the absolute density of the second separation section is 1.58 g/cm³ or more, it is advantageous in terms of the denseness and density conditions necessary for exerting separation performance. On the other hand, when the absolute density of the second separation section is 1.96 g/cm³ or less, it is advantageous in that the permeation resistance of the permeated gas is low, and the pores are narrowed and the separation performance can be exhibited. From the above viewpoint, the absolute density of the second separation section is more preferably 1.67 g/cm³ or more and 1.72 g/cm³ or less.

### <Production Method of Composite Separation Structure>

The simple substance separation structure is produced by the method described above, and the second separation section is formed by exposing the side (upper end portion) of the first substrate section opposite to the side in contact with the substrate section of the first separation section to a gas containing a molecular compound having at least a Si atom.

Hereinafter, a case where an amorphous second separation section is formed in the upper end portion of the zeolite simple substance separation structure in which the first separation section is zeolite will be described. The Si compound containing a Si atom is gasified, and depending on the conditions, is supplied to the upper end portion of the zeolite simple substance separation structure together with water vapor to cause a reaction (exposure treatment). As a result, a thin layer of the Si compound is formed on the upper end portion of the zeolite simple substance separation structure, and the zeolite has a separation layer having pores smaller than the original pore size of the zeolite, and thus it is considered that the separation performance can be improved.

As the molecular compound having a Si atom (Si compound) used in the upper end portion treatment, for example, alkylalkoxysilanes such as methyltriethoxysilane, 3-aminopropyltriethoxysilane and 1,1,3,3-tetramethoxy-1,3-dimethylpropanedisiloxane, organic silicon compounds having siloxane such as hexamethyldisiloxane, organic silicon compounds having silazane such as hexamethyldisilazane, silicates such as tetramethoxysilane and tetraethoxysilane, silicate oligomers such as methylsilicate oligomer and ethylsilicate oligomer, colloidal silica, sodium silicate and silica sol can be used as the liquid raw material before vaporization of the gaseous raw material.

Among these, silicate or silicate oligomer is preferable from the viewpoint of reactivity, and tetraethoxysilane and methyl silicate oligomer are particularly preferable. Further, methyl silicate oligomer is preferred, and polymethoxysiloxane is most preferred.

One of these Si compounds may be used alone or in combination of two or more.

The method of gasifying the Si compound may be vaporization from the Si compound liquid by heating, or may be a gas generated by bubbling the Si compound liquid in a container with an inert gas for transport such as nitrogen, helium, argon, xenon or krypton.

The method of the treatment is not particularly limited as long as the raw material gas can be supplied to the upper end portion of the zeolite simple substance separation structure to cause a reaction. For example, there are the following two cases. One is a method in which a zeolite simple substance separation structure, a Si compound liquid and water are enclosed respectively in a closed reaction container to heat, and a gas generated by vaporization of the Si compound in the closed reaction container is reacted with water vapor generated from water at a high temperature on an upper end portion of the zeolite simple substance separation structure (hereinafter, sometimes referred to as a “closed reaction container system”). The other is a method in which a gas is allowed to flow through a bubbler (gas generator) containing a Si compound, the generated Si compound gas is supplied to a flow-through reaction tube in which a zeolite simple substance separation structure is installed while being accompanied by a carrier gas, and a reaction is caused on an upper end portion of the zeolite simple substance separation structure (hereinafter, sometimes referred to as a “flow-through reactor system”).

First, the treatment by the closed reaction container system will be described.

The closed reaction container system is a method in which a zeolite simple substance separation structure, a gas generated from a Si compound and water vapor generated from water are made to coexist in the inside of a closed reaction container at a desired temperature condition, and reacted on the upper end portion of the zeolite simple substance separation structure. The closed reaction container is not particularly limited, and any container that can accommodate the shape and size of the zeolite simple substance separation structure may be used. For example, a stainless steel autoclave having a Teflon (registered trademark) inner cylinder can be used. When a stainless steel autoclave having a Teflon (registered trademark) inner cylinder is installed in a constant temperature bath having a desired temperature, the temperature and the saturated vapor pressure of water vapor and the gas generated from the supply source of the Si raw material at the temperature are realized, and saturated vapor of the gas generated from the Si raw material and water vapor is generated in the container. The shape of the water vapor and the supply source of the Si raw material are not limited as long as they are put in a closed reaction container. Water and the liquid Si raw material may be put in small containers, respectively, or may be impregnated in a porous material.

The treatment temperature is generally 20° C. or higher, preferably 60° C. or higher, and more preferably 80° C. or higher, and is generally 200° C. or lower, preferably 150° C. or lower, and more preferably 130° C. or lower. When the temperature is equal to or higher than the above lower limit value, the progress of the dehydration condensation reaction and the hydrolysis reaction performed between the Si compound and the upper end portion of the zeolite first separation section and the Si compound becomes sufficient, the modification treatment by the Si compound is sufficiently performed, and the hydrophilicity of the upper end portion of the zeolite first separation section is sufficiently improved. On the other hand, when the temperature is equal to or lower than the above upper limit value, the reaction at the upper end portion of the zeolite first separation section does not proceed too much, the permeation resistance becomes low, and a membrane sample having high permeation performance is obtained.

In the production method of the present invention, all the steps are preferably performed at 200° C. or lower.

The treatment time is usually 1 hour or more, preferably 2 hours or more, and more preferably 3 hours or more, and is usually 24 hours or less, preferably 8 hours or less, and more preferably 5 hours or less. When the treatment time is equal to or more than the above lower limit value, the reaction of the upper end portion of the zeolite first separation section sufficiently proceeds, and a sufficient effect is obtained. On the other hand, when the treatment time is equal to or less than the above upper limit value, the reaction at the upper end portion of the zeolite first separation section does not proceed too much, the permeation resistance becomes low and a membrane sample having high permeation performance is obtained.

Next, the treatment by the flow-through reactor system for the zeolite simple substance separation structure upper end portion treatment will be described.

In this case, the gas generated from the Si compound and the water vapor generated from water are separately generated and supplied to the reaction tube in which the zeolite simple substance separation structure is installed, thereby causing a reaction at the upper end portion of the zeolite simple substance separation structure. According to this method, the gas generated from the Si compound and the water vapor generated from water can be supplied to the reaction tube separately or simultaneously for an arbitrary time. Thus, the treatment can be carried out in multiple stages. That is, there is a stage of simultaneously supplying and distributing a gas generated from the Si compound and water vapor generated from water to the reaction tube, or a stage of supplying and distributing a gas generated from the Si compound or water vapor generated from water separately to the reaction tube and so on. These elementary stages can be arbitrarily combined to constitute the entire treatment.

For example, treatment of the upper end portion of the zeolite simple substance separation structure in the reaction tube is carried out in three successive stages with control of the supply gas. That is, in the first stage, only water vapor generated from water is supplied to the reaction tube using the accompanied carrier gas. At this stage, the water component is adsorbed to the upper end portion of the zeolite simple substance separation structure in the reaction tube. In the second stage, a carrier gas accompanied by both a gas generated from the Si compound and water vapor generated from water is supplied to the reaction tube. In this stage, the Si compound and water vapor react with each other at the upper end portion of the zeolite first separation section. In the third stage, only water vapor generated from water is supplied to the reaction tube using the accompanied carrier gas. In this stage, elimination reactions of organic groups of Si compounds proceed.

The shape of the reaction tube for modification treatment at the upper end portion is not particularly limited. Any container may be used as long as it can accommodate a zeolite simple substance separation structure having any shape and size, such as a tubular shape, a hollow filament shape, a monolith shape, or a honeycomb shape.

The treatment time is usually 1 hour or more, preferably 2 hours or more, and more preferably 3 hours or more, and is usually 24 hours or less, preferably 12 hours or less, and more preferably 8 hours or less. When the treatment time is equal to or more than the above lower limit value, the reaction at the upper end portion of the zeolite first separation section sufficiently proceeds, and a sufficient effect is obtained. On the other hand, when the treatment time is equal to or less than the above upper limit value, the reaction at the upper end portion of the zeolite first separation section does not proceed too much, the permeation resistance becomes low, and a membrane sample having high permeation performance is obtained.

The composite separation structure of the first invention of the present invention is obtained by forming an amorphous silica layer as the second separation section by the above reaction. Conventionally, amorphous silica separation membranes have been reported, but there is no report that they are widely used industrially. This is because the performance of the amorphous silica separation membrane is unstable, and in particular, the stability to moisture is not high. The cause of the instability of the amorphous silica separation membrane is presumed to be that the material is formed under a high-temperature condition of 300° C. or higher, the formed amorphous silica is metastable and structurally unstable, has a reaction activity with moisture, reacts with moisture after membrane formation, and the amorphous silica is denatured to change its permeation performance. That is, it is considered that the instability of these amorphous silica separation membranes is caused by the high temperature condition of the membrane formation. In order to obtain the second separation section made of stable amorphous silica, the formation of amorphous silica at 300° C. or higher is avoided, and the amorphous silica layer is formed at a lower temperature of 200° C. or lower, whereby a stable composite separation structure can be produced. Thus, the water-resistant and stable composite separation structure can be produced.

The treatment temperature is generally 20° C. or higher, preferably 60° C. or higher, and more preferably 80° C. or higher, and is generally 200° C. or lower, preferably 150° C. or lower, and more preferably 130° C. or lower. The most preferred temperature is 100° C. or lower. When the temperature is equal to or higher than the above lower limit value, the progress of the dehydration-condensation reaction and the hydrolysis reaction performed between the Si compound and the upper end portion of the zeolite first separation section and the Si compound becomes sufficient, the modification treatment by the Si compound is sufficiently performed, and the hydrophilicity of the upper end portion of the zeolite first separation section is sufficiently improved. On the other hand, when the temperature is equal to or lower than the above upper limit value, the reaction at the upper end portion of the zeolite first separation section does not proceed too much, the permeation resistance becomes low, and a membrane sample having high permeation performance is obtained.

In the flow-through reactor system (flow-through zeolite simple substance separation structure upper end portion treatment), the flow rate of a gas for bubbling or carrying together a gas of a Si compound and water (hereinafter, referred to as a “supply flow rate”) is not particularly limited, but in order to supply a necessary amount of the Si compound or water for the reaction, the supply flow rate is usually 0.1 mL/min or more, preferably 1 mL/min or more, more preferably 10 mL/min or more, and still more preferably 25 mL/min or more, and the supply flow rate is usually 5000 mL/min or less, preferably 1000 mL/min or less, and more preferably 500 mL/min or less.

The treatment of the upper end portion of the zeolite simple substance separation structure can be performed as follows, for example, by using an apparatus schematically shown in FIG. 2 (flow-through reactor system; raw-material supply gas-flow-through zeolite simple substance separation structure upper end portion reaction-treatment apparatus). That is, in FIG. 2, a container (bubbler) 1 for generating a gas from a Si compound, a container (bubbler) 2 for generating water vapor from water, a tubular reaction tube 3, and a valve 8 are installed in a constant temperature bath 11 by being incorporated into a piping system. The constant temperature bath 11 is provided with a temperature control unit so that the temperatures of these containers (bubblers), the reaction tube and the gas can be adjusted. In the piping system, a gas flow rate controller 4, a water vapor collector 5 in the exhaust gas, a back pressure valve 6, and a gas flow meter 7 are installed outside the constant temperature bath 11.

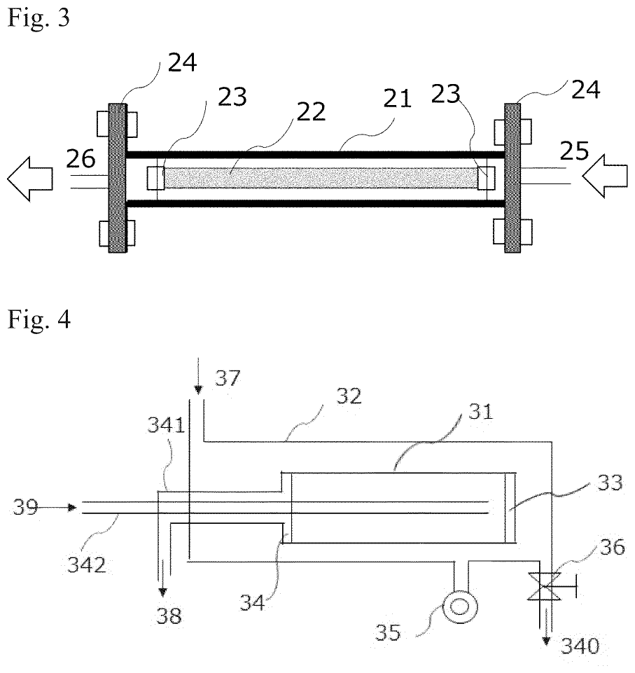

In FIG. 3, a schematic view of a tubular reaction tube 21 (hereinafter, sometimes simply referred to as a “reaction tube”) incorporated as a part of a flow-through reactor system (raw-material supply gas-flow-through zeolite simple substance separation structure upper end portion reaction-treatment apparatus) is shown. In the example shown in FIG. 3, the inner diameter of the tubular reaction tube 21 is 15 mm. In the reaction tube, a tubular zeolite simple substance separation structure 22 having an outer diameter of 12 mm is installed and treated. The zeolite simple substance separation structure 22 is fixed in the reaction tube by a zeolite membrane fixing jig 23 (hereinafter, sometimes simply referred to as a “jig”). The jig 23 has holes or notches, so there is no problem in the flow of gas. By the zeolite membrane fixing jig 23, the distance between the upper end portion of the zeolite simple substance separation structure 22 and the inner wall of the reaction tube 21 is constant, and the supply gas for the reaction stably flows. After installation of the zeolite simple substance separation structure 22, the reaction tube is sealed with a flange 24. The supply gas enters the reaction tube from a supply gas inlet pipe 25, passes through the upper end portion of the tubular zeolite simple substance separation structure 22, and is discharged from an exhaust gas pipe 26. By changing the supply flow rate of the gas, it is possible to control the gas linear velocity and the fluidized state at the upper end portion of the zeolite simple substance separation structure 22.

With reference to FIG. 2, a description will be given of a procedure and convenience for supplying a raw material gas in a flow-through reactor system (raw-material supply gas-flow-through zeolite simple substance separation structure upper end portion treatment apparatus). A porous simple substance-zeolite membrane composite (zeolite simple substance separation structure) to be treated is placed in the tubular reaction tube 3, and the built-in valve 8 of a pipe is closed. Further, the container (bubbler) 1 for generating a gas of a Si compound in which a liquid of a Si compound as a raw material is added and the container (bubbler) 2 for generating water vapor from water in which water is added are incorporated into a pipe, and the valve 8 is closed. The temperature of the constant temperature bath 11 is set to a desired set value to make the temperature in the constant temperature bath uniform. Thereafter, the necessary valves are controlled to supply the gas containing the Si compound gas and the gas containing water vapor to the tubular reaction tube 3 by operating the gas flow rate controller. The type of gas to be supplied (gas containing a Si compound raw material, gas containing water vapor), flow rate, and time can be arbitrarily adjusted. After the treatment step, the gas supplied to the tubular reaction tube 3 passes through the water vapor collector 5, the back pressure valve 6, and the flow meter 7 from the reaction tube, and is discharged to the outside of the apparatus. The back pressure valve 6 is controlled to adjust the pressure in the tubular reaction tube 3.

### <Gas Separation or Concentration>

The separation or concentration method of the present invention includes bringing a mixed gas containing a plural gas components (gas to be separated or concentrated) into contact with the composite separation structure (separation membrane) described in detail above to permeate a component having high permeability from the mixed gas, thereby separating the component having high permeability from the mixed gas or concentrating a component having low permeability by allowing the component having high permeability to permeate from the mixed gas.

In the separation or concentration method of the present invention, a mixed gas (gas to be separated or concentrated) containing a plurality of gas components is brought into contact with the side having the second separation section of the composite separation structure, and the opposite side is pressurized lower than the side in contact with the mixed gas, whereby a component having high permeability (a substance having relatively high permeability in the mixed gas) is selectively permeated from the mixed gas to the void section of the substrate section, that is, as a main component of the permeated substance. Thus, a substance having high permeability can be separated from the mixed gas. As a result, by increasing the concentration of a specific component in the mixed gas (a substance having relatively low permeability in the mixed gas), the specific component can be separated and recovered or concentrated.

The mixed gas to be separated or concentrated is not particularly limited as long as the mixed gas can be separated or concentrated by the composite separation structure of the present invention. In the method of the present invention, examples of the mixed gas to be separated or concentrated include a mixed gas containing at least one component selected from hydrogen, water (water vapor), carbon dioxide, oxygen, nitrogen, methane, ethane, ethylene, propane, propylene, normal butane, isobutane, 1-butene, 2-butene, isobutene, sulfur hexafluoride, helium, carbon monoxide, and nitrogen monoxide. Among these gas components, a gas component having high permeability permeates through the composite separation structure and is separated, and a gas component having low permeability is concentrated on the supply gas side.

In particular, the mixed gas preferably contains at least one kind of gas molecules having a kinetic diameter of 4 Å or less, more preferably contains at least two kinds of gas molecules having a kinetic diameter of 4 Å or less, and most preferably a mixed gas in which all gas molecules constituting the mixed gas have a kinetic diameter of 4 Å or less. According to the present invention, even in a gas containing a component having a kinetic diameter of 4 Å or less as at least one of the components, the component having low permeability can be concentrated with high separation performance by separation of a component having high permeability or by concentration of a component having low permeability. Specific examples of the mixed gas include hydrogen and oxygen, hydrogen and nitrogen, oxygen and nitrogen, air, hydrogen and carbon dioxide, hydrogen and methane, and hydrogen and a lower olefin.

The mixed gas contains at least two kinds of the above components. In this case, as the two kinds of components, a combination of a component having high permeance and a component having low permeance is preferable. Here, the permeance (also referred to as “permeability”) is obtained by dividing the amount of a permeated material by the product of the membrane area, the time and the difference between the partial pressures of the permeating material on the supply side and the permeated side, and the unit thereof is [mol/m²/sec/Pa].

Specific examples of the mixed gas include a mixed gas containing hydrogen and oxygen, a mixed gas containing methane and helium, and a mixed gas containing carbon dioxide and nitrogen, and further include these mixed gases containing water vapor. The present invention can be used for separation or concentration of air, natural gas, a mixed gas of hydrogen, oxygen and water vapor generated by splitting of water, combustion gas, coke oven gas, biogas such as landfill gas generated from a landfill site, and water vapor reformed gas of methane generated and discharged in the petrochemical industry.

When a mixed gas containing hydrogen and oxygen is used, it is preferably used for separating hydrogen from the mixed gas or allowing hydrogen to permeate from the mixed gas. Examples of the mixed gas containing hydrogen and oxygen include a mixed gas of hydrogen and oxygen generated by splitting of water.

In addition, the composite separation structure of the present invention is preferably an aspect in which hydrogen detonating gas having a hydrogen-to-oxygen ratio of 2 and a pressure of 0.2 MPa(G) or less is separated so that a ratio α (H₂/O₂) of hydrogen permeance to oxygen permeance is 10 or more and 110 or less. Since α (H₂/O₂) shows separation performance, it is basically preferable that α (H₂/O₂) is large. However, excessive improvement in separation performance may be accompanied by a decrease in hydrogen permeance itself, and excessive improvement in α (H₂/O₂) is not preferable. According to the study by the present inventors, α (H₂/O₂) is preferably 10 or more and 110 or less, but an aspect in which hydrogen detonating gas is separated so that α (H₂/O₂) is 15 or more and 90 or less is more preferable, and an aspect in which α (H₂/O₂) is 20 or more and 70 or less is still more preferable, and an aspect in which α (H₂/O₂) is 30 or more and 55 or less is most preferable.

In the case of using a mixed gas containing hydrogen, water vapor, and a third gas such as oxygen, it is preferably used for separating hydrogen and water vapor from the mixed gas or allowing hydrogen and water vapor to permeate from the mixed gas. Examples of the mixed gas containing hydrogen, oxygen, and water vapor include a mixed gas of hydrogen, oxygen, and water vapor generated by splitting of water.

When a mixed gas containing carbon dioxide and hydrogen is used, it is preferably used for separating hydrogen from the mixed gas or allowing hydrogen to permeate from the mixed gas. Examples of the mixed gas containing hydrogen and carbon dioxide include a mixed gas derived from a water shift gas.

As the form of the separation membrane module using the composite separation structure of the present invention used for separation of a mixed gas, a flat membrane type, a spiral type, a hollow fiber type, a cylindrical type a honeycomb type and the like are considered, and an optimum form is selected in accordance with an application target. A cylindrical separation membrane module which is one of them will be described. In the following description, a cylindrical separation membrane module including a zeolite composite separation structure, a zeolite simple substance separation structure and the like (sometimes collectively referred to as a zeolite separation structure) will be described, but the composite separation structure of the present invention can also be used for a cylindrical separation membrane module in the same manner as the zeolite separation structure.

In FIG. 4, a zeolite separation structure 31 having a cylindrical shape is installed in a constant temperature bath (not shown) in a state of being stored in a stainless-steel pressure-resistant container 32. The constant temperature bath is provided with a temperature control unit so that the temperature of a sample gas can be adjusted.

In FIG. 4, a zeolite separation structure 31 having a cylindrical shape is installed in a constant temperature bath (not shown) in a state of being stored in a stainless-steel pressure-resistant container 32. The constant temperature bath is provided with a temperature control unit so that the temperature of a sample gas can be adjusted. One end of the cylindrical zeolite separation structure 31 is sealed with a circular end pin 33. The other end is connected with a connection section 34, and the other end of the connection section 34 is connected with the pressure-resistant container 32. The inside of the cylindrical zeolite separation structure 31 and a pipe 341 for discharging a permeated gas 38 are connected to each other via the connection section 34, and the pipe 341 extends to the outside of the pressure-resistant container 32. Further, a pipe 342 for supplying a sweep gas 39 is inserted into the zeolite separation structure 31 via the pipe 341. Furthermore, a pressure gauge 35 for measuring the pressure on the supply side of a sample gas (mixed gas) and a back pressure valve 36 for adjusting the pressure on the supply side are connected to any point leading to the pressure-resistant container 32. Each connection section is connected in an airtight manner.

A sample gas (supply gas 37, gas to be separated) is supplied between the pressure-resistant container 32 and the zeolite separation structure 31 at a constant flow rate, and the pressure on the supply side is made constant by the back pressure valve 36. The sample gas permeates the zeolite separation structure 31 according to the partial pressure difference between the inside and outside of the zeolite separation structure 31, and is discharged through the pipe 341. The gas separation from the mixed gas is performed at a temperature in the range of 0 to 500° C. Considering the separation characteristics of the membrane, the temperature in the range of room temperature to 100° C. is desirable.

In particular, when the zeolite separation structure is a zeolite composite separation structure (composite separation structure of the present invention), it can be applied to separation and concentration of any mixed gas, but in particular, the separation performance of hydrogen and oxygen is significantly higher than that of conventional separation membranes. Therefore, even in the case of separation and concentration of a hydrogen-oxygen mixed gas having a stoichiometric composition (hydrogen:oxygen=2:1), it can be suitably used. Since such a mixed gas is also generated in a process of producing hydrogen by decomposing water by a photocatalyst, such as a so-called artificial photosynthesis plant, it can be said that the present composite separation structure can be more suitably used for separating and concentrating hydrogen in an artificial photosynthesis plant. This is for the following reason.

The mixed gas of hydrogen and oxygen is a mixed gas of a flammable gas and a combustion aid gas, and is so-called hydrogen detonating gas. Among them, hydrogen detonating gas mixed with a stoichiometric composition (hydrogen:oxygen=2:1) has an ignition energy (minimum ignition energy) of about 0.02 mJ, which is extremely low at about 1/10 of that of hydrocarbons, and once ignited, its explosive power is also maximum. In other words, the hydrogen-oxygen mixed gas (hydrogen detonating gas) is extremely easy to ignite, and easily transitions to a detonation state in which the detonation speed exceeds the sound speed when detonating. Therefore, in the artificial photosynthesis plant, it is required to safely and efficiently separate the hydrogen-oxygen mixed gas generated in the photocatalytic reactor into hydrogen and oxygen.

From the viewpoint of safety, at the time of separation of the hydrogen-oxygen mixed gas, it is preferable to separate and concentrate hydrogen by reducing the pressure on the permeation side where hydrogen permeates and the hydrogen concentration becomes high, that is, the permeation side of the present composite separation structure by a vacuum pump. The pressure is preferably −0.03 MPa(G) or less, more preferably −0.06 MPa(G) or less, still more preferably −0.09 MPa(G) or less, and most preferably −0.1 MPa(G) or less. By doing so, even if an ignition risk due to static electricity occurs on the permeation side of the present composite separation structure, actual ignition is suppressed due to depressurization. Therefore, it is preferable that the permeation side pressure of the present composite separation structure is low. Further, since the differential pressure to the supply side, which is the driving force of the hydrogen-oxygen separation, can be large, it is preferable that the permeation side pressure of the present composite separation structure is low.

Furthermore, from the viewpoint of safety, the hydrogen concentration on the permeation side (hydrogen-rich side) where hydrogen permeates and the hydrogen concentration becomes high by the present composite separation structure is preferably outside the explosive range as much as possible, and is preferably 96% or more, more preferably 97% or more, still more preferably 98% or more, and most preferably 99% or more. This is because when the hydrogen concentration in the hydrogen-oxygen mixed gas is 95 to 96% or more, the hydrogen concentration is out of the explosive range.

On the other hand, from the viewpoint of efficiency, the hydrogen recovery rate defined by the ratio of the amount of hydrogen on the permeation side (hydrogen-rich side) to the amount of hydrogen contained in the gas to be separated supplied to the present composite separation structure is preferably 80% or more, more preferably 85% or more, still more preferably 90% or more, even more preferably 93% or more, and most preferably 96% or more. It is preferable to realize a high hydrogen recovery rate because it means a reduction in hydrogen production cost.

When the present composite separation structure is applied to an artificial photosynthesis plant to improve the hydrogen concentration on the further downstream side of the permeation side of the present composite separation structure, for example, when residual oxygen flowing out to the permeation side is removed by reacting with hydrogen in a post-treatment step using a catalyst, the amount of hydrogen consumed in the post-treatment step can be reduced as the hydrogen concentration on the permeation side is higher, that is, as the oxygen concentration on the permeation side is lower. For this reason, it is very preferable to apply the present composite separation structure having a significantly higher hydrogen-oxygen separation performance than the conventional one to an artificial photosynthesis plant from the viewpoint of improving the effective hydrogen production amount in the entire artificial photosynthesis plant.

In other words, an artificial photosynthesis plant which is “an artificial photosynthesis plant having at least a photocatalyst reactor and a separation membrane portion, in which the separation membrane portion is a composite separation membrane satisfying at least one of the following four features A to D” is very preferable. Here, the composite separation structure has a substrate section, a first separation section disposed in contact with the substrate section, and a second separation section disposed not in contact with the substrate section but in contact with the first separation section; in which A) the second separation section has an amorphous structure; B) the second separation section has a thickness from an end portion in contact with the first separation section to the opposite end portion of 5 nm or more and 200 nm or less; C) the second separation section is amorphous and has a relative density of 1.05 or more and 1.30 or less with respect to the first separation section; and D) the second separation section is amorphous and has an absolute density of 1.58 g/cm³ or more and 1.96 g/cm³ or less.

In addition, an artificial photosynthesis plant which is “an artificial photosynthesis plant having at least a photocatalyst reactor and a separation membrane portion, in which the separation membrane portion is a composite separation membrane satisfying at least one of the following four features E to H” is very preferable. Here, the composite separation structure has a substrate section, a first separation section disposed in contact with the substrate section, and a second separation section disposed not in contact with the substrate section but in contact with the first separation section; and the hydrogen-oxygen separation performance α (H₂/O₂) of the composite separation structure is E) 10 or more and 110 or less, F) 15 or more and 90 or less, G) 20 or more and 70 or less, and H) 30 or more and 55 or less.

In addition, it is very preferable that the present composite separation structure composed of an inorganic material is applied to an artificial photosynthesis plant from the viewpoint of not increasing flame propagation in the event of ignition of a hydrogen-oxygen mixed gas, as compared with an organic membrane.

Particularly, the homogeneity of the second separation section in the composite separation structure of the present invention is important for realizing high separation membrane performance when applied to gas separation, and can be evaluated by calculating the “ratio of variance in density” or the “ratio of high-density region”. Here, the “ratio of variance in density” is defined as a material parameter related to the uniformity of the second separation section with reference to the first separation section. In addition, the “ratio of high-density region” is a material parameter focusing on a characteristic that a sufficient separation performance can be exhibited when the “ratio of high-density regions” is in an appropriate range from the study of the present inventors.

As a practical matter, however, this definition is only for a very small area, so it is impossible to see the whole. Therefore, in practice, a region subjected to the processing described below is measured at arbitrary several positions (arbitrary about four positions), and a typical value is regarded as the value of the whole.

To obtain these values, a measurement can be performed by a method similar to that described in Examples below. That is, the values can be obtained by processing the upper end portion of the zeolite simple substance separation structure with a focused ion beam (FIB), preparing a thin piece having a thickness of 120 nm, and analyzing an image observed under HAADF-STEM (High Angle Annular Dark-Field Scanning Transmission Electron Microscopy) conditions.

### Fifth Invention of the Present Application

The fifth invention of the present application relates to a composite separation structure in which the above-mentioned “ratio of variance in density” is specified. Concretely, the composite separation structure has a substrate section, a first separation section disposed in contact with the substrate section, and a second separation section disposed not in contact with the substrate section but in contact with the first separation section, in which a ratio of variance in density of the second separation section to that of the first separation section is 0.001 or more and 0.08 or less.

Here, the “ratio of variance in density” is a material parameter obtained by dividing the value of the second separation section by the value of the first separation section with respect to the sum of the absolute values of dissociations between the average value of the number of pixels in the luminance range indicating the number of pixels of 1% or more of the maximum frequency and the real number, after acquiring the histogram of the number of pixels as the frequency for an 8-bit grayscale (256 luminance gradations from 0 to 255) for each of the first separation section and the second separation section for the image acquired by the above-described HAADF-STEM measurement. The second separation section needs to be formed uniformly in order to obtain high membrane performance.

Although the first separation section alone described in the present invention can exhibit a certain degree of separation performance, the second separation section is required to be more uniform than the first separation section to improve the separation performance to a practical level. From this viewpoint, it is preferable that the ratio of variance in density is a small value in a positive range. Specifically, the “ratio of variance in density” is preferably 0.08 or less, more preferably 0.04 or less, and most preferably 0.02 or less. On the other hand, since the membrane has pores at a molecular level to exhibit a separation function, the ratio of variance in density does not become zero, becomes a positive value, and is effectively 0.001 or more.

### Sixth Invention of the Present Application

The sixth invention of the present application relates to a composite separation structure in which the above-mentioned “ratio of high-density region” is specified. Concretely, the composite separation structure has a substrate section, a first separation section disposed in contact with the substrate section, and a second separation section disposed not in contact with the substrate section but in contact with the first separation section, wherein a part of the second separation section has a high-density region, and a ratio of the high-density region to the entire second separation section is 0.02 or more and 0.1 or less.

The “ratio of high-density region” is obtained by acquiring an 8-bit grayscale (256 luminance gradations from 0 to 255) of the second separation section and a histogram of the number of pixels as the frequency thereof for the image acquired by the above-described HAADF-STEM measurement, performing a 5-unit moving average processing and an interpolation processing in which the number of luminance categories is 1000, and then dividing the total value of the frequency values of regions indicating a frequency smaller than the average value on the high luminance side of the peak range with respect to the average value of the number of pixels in the luminance category range indicating the number of pixels of 1% or more of the maximum frequency by the total value of the frequency values of other regions.

The present inventors have found that in a case where the “ratio of high-density region” takes an excessively large value, that is, in a case where an excessively localized high-density region is present in the second separation section, an excessively localized low-density region is present at the same time. This is presumed to be because local aggregation occurs at the time of forming the second separation section, and a low-density region is generated around the high-density region. On the other hand, according to the study of the present inventors, in a case where the “ratio of high-density region” has an excessively small value, there is a concern that the supply of raw materials during the formation of the second separation section is insufficient, and it is suggested that the density of the second separation section is reduced more than necessary. In any case, since the presence of the low-density region causes a decrease in the separation performance with respect to the target gas, it has been found that there is an appropriate range in the “ratio of high-density region”.

According to the study by the present inventors, it has been revealed that the “ratio of high-density region” in the present invention is preferably 0.02 or more and 0.1 or less. Furthermore, it has been found that the lower limit of the “ratio of high-density region” is more preferably 0.03 or more, still more preferably 0.04 or more, and most preferably 0.05 or more. On the other hand, it has been found that the upper limit thereof is more preferably 0.095 or less, still more preferably 0.09 or less, and most preferably 0.085 or less.

### EXAMPLES

Hereinafter, the present invention will be more specifically described based on experimental examples (Examples), but the present invention is not limited to the following experimental examples as long as it does not go beyond the gist thereof. The values of various production conditions and evaluation results in the following experimental examples have a meaning as preferred values of the upper limit or the lower limit in the embodiments of the present invention, and a preferred range may be a range defined by a combination of the above-described upper limit or lower limit value and a value in the following Examples or a value between Examples.

### <Measurement of Physical Properties and Separation Performance>

In the following experimental examples, measurements of physical properties and permeation separation were performed as follows unless otherwise specified. In addition, in the present Examples, zeolite is used as a material of the first separation section, and thus the following measurement methods are described as measurement methods relating to zeolite simple substance separation structure.

### (1) X-Ray Diffraction (XRD) Measurement

XRD measurement of the zeolite simple substance separation structure was performed under the following conditions.
Apparatus name: X'PertPro MPD manufactured by Malvern Panalytical B.V., Netherlands
Optical system specifications, Incident side: sealed X-ray tube (CuKα)
Soller Slit (0.04 rad)
Divergence Slit (Valiable Slit)
Sample stage: XYZ stage
Light receiving side: semiconductor array detector (X'Celerator)
Ni-filter
Soller Slit (0.04 rad)
Goniometer radius: 240 mm
Measurement conditions, X-ray output (CuKα): 45 kV, 40 mA
Scanning axes: θ/2θ Scanning range (2θ): 5.0° to 70.0°
Measurement mode: Continuous
Reading width: 0.05°
Counting time: 99.7 sec
Automatic variable slit (Automatic-DS): 1 mm (irradiation width)
Lateral divergence mask: 10 mm (irradiation width)

The X-ray was irradiated in a direction perpendicular to the axial direction of the cylindrical tube. In addition, the X-ray was irradiated mainly on the other line of two lines on which the cylindrical tubular zeolite simple substance separation structure 106 placed on the sample stage and a plane parallel to the surface of the sample stage are in contact with each other, the other line being located the surface of above the sample stage, not on the surface of the sample stage, in order to prevent noise from entering as much as possible.

In addition, the irradiation width was fixed to 1 mm by an automatic variable slit for measurement, and the variable slit was converted into a fixed slit using XRD analysis software JADE 7.5.2 (Japanese version) of Materials Data, Inc. to obtain an XRD pattern.

### (2) TEM Observation

### (2-1) Preparation of TEM Observation Sample

For TEM (transmission type electron microscope) observation of the upper end portion of the zeolite simple substance separation structure, the upper end portion of the composite separation structure was processed with a focused ion beam (FIB) to prepare a thin piece.

### (2-2) TEM (Transmission Type Electron Microscope) Observation, Composition Analysis, and Density Measurement

TEM (transmission type electron microscope) structural observation, density measurement, and composition analysis of the upper end portion of the zeolite simple substance separation structure and the second separation section were performed under the following conditions.
Analytical transmission scanning type electron microscope apparatus name: Talos F200X, manufactured by Thermo Fisher Scientific Inc.
Acceleration voltage: 200 kV.
HAADF-STEM (High Angle Annular Dark-Field Scanning Transmission Electron Microscopy, high angle scattering annular dark-field scanning transmission microscopy)
Camera lens: 98 mm
Capturing angle: 37 to 200 mrad

The strength (Is) was measured under the above conditions.

As shown in the following equation (1), Is is proportional to a value σθ1θ2 obtained by integrating the Rutherford scattering strength from θ1 to θ2, the number of atoms N and the sample thickness t.

$$Is = σθ1θ2 \cdot NtI 0 \qquad ( 1 )$$

### Composition Analysis Measurement by Energy Dispersive X-Ray Spectroscopy (EDS)

In the measurement of the composition of the surface layer, EDX mapping was performed under the above-described HAADF-STEM condition, an area region of 35 nm×35 nm was extracted with respect to the zeolite and the surface membrane thereon, and the composition values (atomic %) of oxygen, aluminum, and silicon were obtained. In consideration of local composition errors, the measurement was performed at 10 points for each second separation section, and the average value was obtained.

### (2-3) TEM (Transmission Type Electron Microscope) Observation

TEM (Transmission type Electron Microscope) observation of the upper end portion of the zeolite simple substance separation structure and the second separation section, and thickness measurement of the second separation section were carried out under the following conditions.
Apparatus name: H-9500 manufactured by Hitachi High-Tech Corporation
Acceleration voltage: 200 kV

### (3) Single Component Gas Permeation Test

The single component gas permeation test was performed as follows using an apparatus schematically shown in FIG. 4. The sample gases used were hydrogen (hydrogen generator by water splitting), carbon dioxide (purity 99.9%, manufactured by Koatsu Gas Kogyo Co., Ltd.), methane (purity 99.999%, manufactured by Taiyo Nippon Sanso JFP Corporation), nitrogen (purity 99.99%, manufactured by Toho Sanso Kogyo Co., Ltd.), and helium (purity 99.99%, manufactured by Japan Helium Center Corporation).

In FIG. 4, a cylindrical zeolite separation structure (including a zeolite composite separation structure and a zeolite simple substance separation structure) 31 is installed in a constant temperature bath (not shown) in a state of being stored in a stainless-steel pressure-resistant container 32. The constant temperature bath is provided with a temperature control unit so that the temperature of a sample gas can be adjusted. One end of the cylindrical zeolite separation structure 31 is sealed with a circular end pin 33. The other end is connected with a connection section 34, and the other end of the connection section 34 is connected with the pressure-resistant container 32. The inside of the cylindrical zeolite separation structure 31 and a pipe 341 for discharging a permeated gas 38 are connected to each other via the connection section 34, and the pipe 341 extends to the outside of the pressure-resistant container 32. Further, in the zeolite separation structure 31, a pipe (sweep gas introduction pipe) 342 for supplying a sweep gas 39 is inserted into the pipe 341. Furthermore, a pressure gauge 35 for measuring the pressure on the supply side of a sample gas and a back pressure valve 36 for adjusting the pressure on the supply side are connected to any point leading to the pressure-resistant container 32. Each connection section is connected in an airtight manner.

In the apparatus shown in FIG. 4, when the single component gas permeation test is performed, the sample gas (supply gas 37) is supplied between the pressure-resistant container 32 and the zeolite separation structure 31 at a constant flow rate, the pressure on the supply side is made constant by the back pressure valve 36, and the flow rate of a discharge gas 340 is measured. To be more specific, in order to remove components such as moisture and air, after drying at a temperature equal to or higher than the measured temperature and purging with exhaust gas or the supply gas to be used, the sample temperature and the differential pressure between the supply gas 37 side and the permeated gas 38 side of the zeolite separation structure 31 are set to be constant, and after the permeated gas flow rate is stabilized, the flow rate of the sample gas (permeated gas 38) that has permeated the zeolite separation structure 31 is measured, and the permeance [mol/m²/sec/Pa] of the gas is calculated. To calculate the permeance, the pressure difference (differential pressure) between the supply side and the permeation side of the supply gas is used.

Based on the above measurement results, the ideal separation factor α is calculated by the following equation (2).

$$α = ( Q 1 / Q 2 ) / ( P 1 / P 2 ) \qquad ( 2 )$$

[In the equation (1), Q1 and Q2 indicate the permeation amount [mol/m²/sec] of a gas having high permeability and a gas having low permeability, respectively, and P1 and P2 indicate the pressure [Pa] of a gas having high permeability and a gas having low permeability, respectively, which are supply gases.]

### (4) Mixed Gas Permeation Test

The mixed gas permeation test of the zeolite separation structure was performed in the same manner as the single component gas permeation test except for the following matters by using an apparatus schematically shown in FIG. 4. The mixed gas was an oxygen-nitrogen mixed gas, air (pure air, 99.999%, manufactured by TAIYO NIPPON SANSO CORPORATION).

In the mixed gas permeation test, the mixed gas is supplied as the supply gas 37 in FIG. 4. The gas that has permeated through the zeolite separation structure (38 in FIG. 4) and the gas that has not permeated through the zeolite separation structure (340 in FIG. 4) are fractionated and subjected to component analysis by gas chromatography.

As an index of the performance of a membrane for separating hydrogen from a mixed gas containing hydrogen and oxygen, a performance obtained by directly permeating and separating a mixed gas of hydrogen and oxygen is most preferable. However, the mixed gas containing hydrogen and oxygen is highly explosive, and the measurement of the permeation separation performance is dangerous. On the other hand, the following index is considered as an index of the performance of a membrane for separating hydrogen from a mixed gas containing hydrogen and oxygen which can be conveniently obtained. That is, a ratio of the permeance obtained by the measurement of the permeation performance of a single component gas of hydrogen to the oxygen permeance obtained by the measurement of the permeation separation performance of air is used as an index of the separation performance. In the present application, the ratio of the permeance (denoted by PH₂) obtained by the measurement of the permeation performance of a single component gas of hydrogen to the oxygen permeance (denoted by P[O₂]) obtained from the measurement of the permeation separation performance of air is defined as the separation factor (β) of hydrogen and oxygen. The separation factor (β) is expressed by Equation (3).

$$β = {PH}_{2} / P [ {O}_{2} ] \qquad ( 3 )$$

The ideal hydrogen-oxygen separation factor is originally the permeance (PH₂) obtained by the measurement of the permeation performance of a single component gas of hydrogen and the permeance (PO₂) obtained by the measurement of the permeation performance of a single component gas of oxygen. In the quasi-ideal separation factor (β) of the present application, the oxygen permeance (P[O₂]) obtained from the measurement of the permeation separation performance of air, which is a mixed gas of nitrogen and oxygen, is used instead of the permeance obtained from the measurement of the permeation performance of a single component gas of oxygen.

### (5) Measurement of Permeation Separation Performance of Mixed Gas Containing Water Vapor

A mixed gas permeation test of the zeolite separation structure was performed as follows using an apparatus schematically shown in FIG. 4. Before supplying the mixed gas containing water vapor to the apparatus schematically shown in FIG. 4, part of the mixed gas was passed through a water bubbler to be accompanied by water vapor, and the dew point of the mixed gas containing water vapor was measured in situ using a dew point sensor incorporated in a pipe. Thereafter, the mixed gas containing water vapor was introduced into the pressure-resistant container 32 of the apparatus as a supply gas 37 of the apparatus schematically shown in FIG. 4. Further, after the separation and permeation treatment of the mixed gas, the dew point of the mixed gas containing water vapor was measured in situ using a dew point sensor in which a permeated gas and a discharge gas were respectively incorporated in a pipe. The density of water was found from the dew point measurement, and the permeation amount of water was calculated. The method for measuring the gas flow rate and determining the permeation performance is the same as in the mixed gas permeation test.

### <Measurement of Permeation Separation Performance of Hydrogen and Oxygen>

The composite separation structure of the present invention can also be suitably used for the mixed gas separation of hydrogen:oxygen=2:1 (stoichiometric composition) generated by the total splitting of water in an artificial photosynthesis plant equipped with a photocatalyst material, and can separate hydrogen and oxygen safely and with high efficiency. At this time, although the supply pressure of the supply gas can be arbitrarily selected, the gas to be separated may be hydrogen detonating gas (hydrogen-oxygen mixed gas), and therefore, an excessive supply pressure should be avoided for safety. Therefore, the supply pressure is 0.400 MPa(G) or less, preferably 0.300 MPa(G) or less, more preferably 0.200 MPa(G) or less, still more preferably 0.100 MPa(G) or less, and most preferably 0.050 MPa(G) or less.

On the other hand, the supply pressure is preferably 0.010 MPa(G) or more, more preferably 0.015 MPa(G) or more, still more preferably 0.020 MPa(G) or more, and most preferably 0.025 MPa(G) or more, in order to ensure a supply pressure equal to or higher than the pressure loss of the pipe.

In addition, although the pressure on the permeation side can also be arbitrarily selected, a preferable range can be selected from the following two viewpoints.

One is a case where the pressure is reduced in order to secure a differential pressure at the separation membrane portion without excessively increasing the supply pressure. The permeation pressure in the case of reduced pressure is preferably −0.0600 MPa(G) or less, more preferably −0.0700 MPa(G) or less, still more preferably −0.0800 MPa(G) or less, and most preferably −0.0900 MPa(G) or less. On the other hand, when the pressure on the permeation side is excessively reduced, recoverable hydrogen (inherent energy) may be practically reduced by electric energy consumed for operating a vacuum pump. Therefore, the permeation pressure in the case of reduced pressure is preferably −0.1010 MPa(G) or more, more preferably −0.1005 MPa(G) or more, still more preferably −0.1000 MPa(G) or more, and most preferably −0.0995 MPa(G) or more.

On the other hand, from the other point of view, that is, from the viewpoint of suppressing the energy consumption in the vacuum pumps as much as possible, it is preferable to set the permeation pressure near the atmosphere pressure (near 0.0 MPa(G)). The permeation pressure in this case is comprehensively determined by the flow rate, the pipe size and the pressure loss, and the permeation pressure in the subsequent stage of the separation membrane is preferably 0.040 MPa(G) or less, more preferably 0.030 MPa(G) or less, still more preferably 0.020 MPa(G) or less, and most preferably 0.010 MPa(G) or less.

On the other hand, in order not to excessively increase the pipe size, the permeation pressure is preferably 0.001 MPa(G) or more, more preferably 0.002 MPa(G) or more, still more preferably 0.003 MPa(G) or more, and most preferably 0.004 MPa(G) or more.

In general, in the separation of the mixed gas, when the first component gas having a relatively high permeance and the second component gas having a relatively low permeance are separated, the required permeance or the ratio thereof may differ depending on how the differential pressure between the supply pressure and the permeation pressure applied to the separation membrane is applied. From the above study, the permeance ratio indicating the permeance or separation performance of various gases in the present invention is defined such that the supply pressure is in the range of 0.010 MPa(G) to 0.400 MPa(G), and the permeation pressure is in the range of −0.1010 MPa(G) to 0.040 MPa(G).

The characteristics of the composite separation structure of the present invention can be changed by changing the membrane-forming conditions. Therefore, the functionality can be further improved by connecting a plurality of composite membranes or composite membrane modules having different characteristics. Further, in such a connection, it is also possible to connect a conventionally known organic membrane such as an amide membrane or an imide membrane and the composite separation structure of the present invention. Further, it is also possible to connect a conventionally known silica membrane, a carbon membrane, a zeolite simple substance separation structure having various framework structures, and the composite separation structure of the present invention.

In a membrane-connected connecting membrane module, or in a connecting module in which modules containing membranes are connected to each other, it is more preferable that membranes having different characteristics are connected to each other or modules having different characteristics are connected to each other. For example, a connection of a composite separation structure and a conventionally known silica membrane is preferable. In addition, a connection of a composite separation structure and a conventionally known carbon membrane is also preferable. In these, it is more preferable that the former is a relatively highly permeable membrane and the latter is a relatively highly selective membrane so that the performance of the whole of the connected membranes can be further improved.

### Example 1

As a reaction mixture for hydrothermal synthesis, the following was prepared.

2.43 g of aluminum hydroxide (containing 53.5% by mass of Al₂O₃, manufactured by Aldrich) was added to a mixture of 1.44 g of a 1 mol/L NaOH aqueous solution, 5.76 g of a 1 mol/L KOH aqueous solution and 114.01 g of water to stir and dissolve, resulting in a transparent solution. 12.15 g of TMADAOH aqueous solution (containing 25% by mass of TMADAOH, manufactured by SACHEM, Inc.) as an organic template was added thereto, and 10.8 g of colloidal silica (Snowtex-40, manufactured by Nissan Chemical Corporation) was further added thereto, and the mixture was stirred for 30 minutes to obtain a reaction mixture.

The composition (molar ratio) of the reaction mixture was SiO₂/Al₂O₃/NaOH/KOH/H₂O/TMADAOH=1/0.014/0.02/0.08/100/0.04, and SiO₂/Al₂O₃=70.

An alumina tube (outer diameter: 12 mm, inner diameter: 9 mm) cut into a length of 80 mm was used as an inorganic porous substrate section.

As a seed crystal, a CHA-type zeolite obtained by hydrothermally synthesized from a gel composition (molar ratio) of SiO₂/Al₂O₃/NaOH/KOH/H₂O/TMADAOH=1/0.033/0.1/0.06/20/0.07 at 160° C. for 2 days and crystallized was used. The above substrate was immersed in a dispersion of 1.0 mass % seed crystals in water for 30 seconds, and then pulled up to support the seed crystals on the upper end portion of the inorganic porous substrate section for hydrothermal synthesis.

A total of three substrate sections, that is, the substrate section to which the seed crystal was thus attached and two substrate sections to which the seed crystal was similarly attached, were immersed in a Teflon (registered trademark) inner cylinder (200 mL) containing the above reaction mixture in a vertical direction, and the autoclave was sealed and heated in a stationary state at 180° C. for 18 hours under autogenous pressure to grow zeolite crystals at the upper end portion of the inorganic porous substrate section by hydrothermal synthesis. Thereafter, cooling was performed, the zeolite simple substance separation structure was taken out from the reaction mixture, washed, and dried at 100° C. for 2 hours or more.

The zeolite simple substance separation structure before template burning was burned in an electric oven at 500° C. for 5 hours. The mass per unit area of the CHA-type zeolite crystallized in the upper end portion of the substrate section, which was determined from the difference between the mass of the zeolite simple substance separation structure after burning and the mass of the substrate section, was 60 g/m². When XRD of the formed membrane was measured, it was found that a CHA-type zeolite was formed. In the X-ray diffraction pattern, the peak intensity in the vicinity of 2θ=9.6° was 2.5 times the peak intensity in the vicinity of 2θ=20.8°.

The CHA-type zeolite simple substance separation structure having a length of 80 mm obtained by such a synthesis method was subjected to a zeolite simple substance separation structure upper end portion treatment at 100° C. using the apparatus shown in FIG. 2 by supplying supply gases at 50 mL/min through a bubbler containing water vapor and a bubbler containing polymethoxysiloxane (MKC (registered trademark) silicate, MS-56, manufactured by Mitsubishi Chemical Corporation), which is a methyl silicate oligomer, as a silica source, respectively to a reaction tube (FIG. 3) in which the CHA-type zeolite simple substance separation structure was placed, thereby preparing a composite separation structure. In the supply of each raw material by gas from a bubbler, nitrogen gas was used for the supply of water vapor, and helium was used for the supply of silica source. The reaction tube is a stainless-steel tube having an inner diameter of 15 mm, an outer diameter of 20 mm, and a full-length of 440 mm, and both ends of the reaction tube can be connected to a gas supplying pipe by a flange so that a gas can flow through the reaction tube. In the treatment, only the gas accompanied by water vapor was supplied and allowed to flow through the reaction tube for the first 1 hour (first treatment stage), a mixture of the gas accompanied by water vapor and the gas accompanied by and carrying polymethoxysiloxane was supplied and allowed to flow through the reaction tube for the next 1 hour (second treatment stage), and only the gas accompanied by water vapor was supplied and allowed to flow through the reaction tube for the next 1 hour (third treatment stage). After the treatment process, the inside of the reaction tube was allowed to cool, and then the composite separation structure was taken out and further heat-treated at 130° C. for 1 hour.

The obtained composite separation structure was mounted in a separation membrane module as a membrane length of 4.94 cm to complete preparation for a gas separation experiment.

In the experiment, a mixed gas of hydrogen and oxygen was used as a gas to be separated, and a total of 200.0 mL/min was supplied to the separation membrane by setting the former to 133.3 mL/min and the latter to 66.7 mL/min. The mixed gas to be separated was prepared on the assumption of the total splitting of water in an artificial photosynthesis plant equipped with a photocatalytic material, and the composition thereof was a stoichiometric composition of hydrogen:oxygen=2:1. In addition, the supply pressure at this time was set to 0.1 MPa(G). Further, a vacuum pump was installed on the permeation side of the separation membrane module to reduce the pressure on the permeation side to about −0.1 MPa(G). The module temperature was set to 50° C., and a continuous gas separation experiment was performed for more than 100 hours.

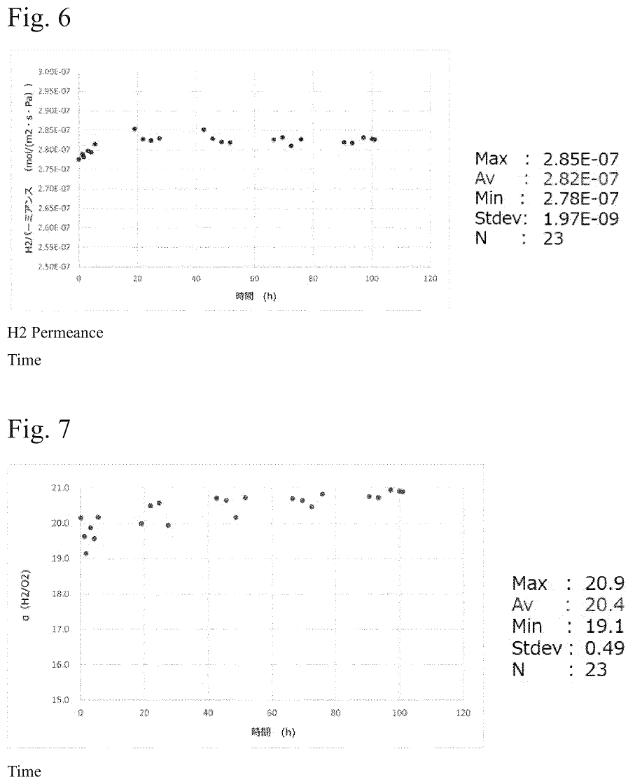

FIG. 6 shows the change with time of the hydrogen permeance at that time, and FIG. 7 shows the change with time of the ratio of the hydrogen permeance to the oxygen permeance. As the figures showed, stable gas separation of hydrogen and oxygen was confirmed for 100 hours continuously, with the average value of the hydrogen permeance P(H₂) of 2.82E-7 [mol/m²/sec/Pa] and an average value of the oxygen permeance P(O₂) of 1.38E-8 [mol/m²/sec/Pa], and the average value of their ratio, α (H₂/O₂), was 20.4.

Furthermore, from the viewpoint of the gas separation process, when the data after 3097 minutes have elapsed under the conditions, the permeation side flow rate was 78.7 mL/min and the hydrogen concentration was 96.4%, and it was possible to set the outside of the detonation range (hydrogen concentration of 4% or more and 96% or less) of the hydrogen-oxygen mixed gas (hydrogen detonating gas). In addition, the hydrogen recovery rate was 56.9%.

In this way, high selectivity of hydrogen and oxygen, which cannot be achieved only by the CHA-type zeolite simple substance separation structure, was realized by the composite separation structure. At the same time, high hydrogen permeance was successfully maintained. Further, as a result, the hydrogen-oxygen mixed gas (hydrogen detonating gas) on the permeation side was successfully made to be outside of the detonation range (hydrogen concentration of 4% or more and 96% or less).

### Example 2

A tubular CHA-type zeolite simple substance separation structure having a length of 400 mm was prepared by a hydrothermal synthesis treatment and an upper end portion treatment in the same manner as in Example 1, except that a tubular alumina substrate section having a length of 400 mm was used.

The obtained zeolite simple substance separation structure having a length of 400 mm was put into a reaction tube of a raw-material supply gas-flow-through zeolite simple substance separation structure upper end portion treatment apparatus shown in FIG. 2 without changing the length of 400 mm as a total length of 400 mm, and the upper end portion treatment was performed in the same manner as in Example 1 except for the flow rate of the supply gas. In order to confirm the structure near the upper end portion of the obtained composite separation structure, the sample was processed as follows.

A thin piece for transmission electron microscope (TEM) observation having a thick membrane portion of 120 nm and a thin membrane portion of 75 nm was prepared by using an FIB (focused ion beam) processing apparatus for the cross-sectional portion near the surface of the composite separation structure, and the thin piece was stored in a vacuum chamber. The apparatus used for TEM observations was a 200 kV analytical transmission scanning electron microscope apparatus (name; Talos F200X, manufactured by Thermo Fisher Scientific Inc.). Further, the density and the composition of the second separation section were measured by adjusting the acceleration voltage of the apparatus to 200 keV, setting the apparatus to the HAADF-STEM condition, and setting the camera lens to 98 mm.

In this condition, the Bragg reflection is not mixed, and the intensity Is of the HAADF-STEM with an uptake angle of 37 to 200 mrad, which provides the most structural information of zeolite silica, can be obtained. As shown in the following Equation (1), Is is proportional to a value σθ1θ2 obtained by integrating the Rutherford scattering strength from θ1 to θ2, the number of atoms N, and the sample thickness t.

$$Is = σθ1θ2 \cdot NtI 0 \qquad ( 1 )$$

The measurement of the Is value by the HAADF-STEM method is suitable as a technique for measuring the density of the nano region like the purpose. In this measurement, Is values were measured at 256 points at intervals of 0.576 nm using an electron beam probe narrowed to 0.12 nmφ, and the average value was used.

In the measurement of the composition of the second separation section, EDX mapping was performed under the HAADF-STEM condition, an area region of 35 nm×35 nm was extracted with respect to the second separation section, and the composition values (atomic %) of oxygen, aluminum and silicon were obtained. In consideration of local composition errors, the measurement was performed at 10 points in the second separation section, and the average value was obtained.

As a result, it was found that the second separation section had an amorphous structure. The silica layer of the second separation section was 13 nm thick. As a result of the composition analysis by EDX, oxygen was 69.39 atomic %, aluminum was 1.48 atomic % and silicon was 30.54 atomic %. The zeolite in the first separation section was 3.8 μm thick.

Further, the relative density of the second separation section (amorphous structure) was 1.103615454 in the thick membrane portion and 1.124425201 in the thin membrane portion when the CHA-type zeolite was taken as 1, and it was found that the material density was relatively higher than that of the CHA-type zeolite layer. Further, the absolute density thereof was 1.67 (g/cm³). Here, the absolute density is a value obtained by calculation from the measured relative density, assuming that the absolute density of the CHA-type zeolite simple substance separation structure is 1.502 (NPL 7). As the relative density, an average value of a measured value in a thick membrane portion and a measured value in a thin membrane portion was adopted. It has been found that this absolute density of 1.67 (g/cm³) is a special layer having a density lower than that of commonly known amorphous silica (NPL 6). From these analyses, it is presumed that the amorphous silica layer formed on the zeolite simple substance separation structure by the method of the present inventors has a relatively higher material density than that of the zeolite layer, and thus can express extremely excellent performance as a gas separation membrane in that high hydrogen-oxygen separation performance can be expressed and relatively high hydrogen permeance can be realized because the absolute density is lower than that of normal amorphous silica.

### Example 3

One 400 mm length CHA-type zeolite simple substance separation structure obtained in the same manner as in the synthesis method shown in Example 2 was divided into two 200 mm lengths, and the two zeolite simple substance separation structures as a total length of 400 mm were put into a reaction tube of a raw-material supply gas-flow-through zeolite simple substance separation structure upper end portion treatment apparatus shown in FIG. 2 to perform an upper end portion treatment. The upper end portion treatment of the zeolite simple substance separation structure was performed in the same manner as in Example 1, except that polymethoxysiloxane (MKC (registered trademark) silicate, MS-51, manufactured by Mitsubishi Chemical Corporation), which is a methyl silicate oligomer, was used as the Si compound, and the flow rate of the supply gas was set to 75 mL/min for both raw materials (Si compound and water). The obtained composite separation structure was mounted in a separation membrane module as a membrane length of 17.3 cm to complete preparation for a gas separation experiment.

In the experiment, a mixed gas of hydrogen and oxygen was used as a gas to be separated, and a total of 200.0 mL/min was supplied to the separation membrane by setting the former to 133.3 mL/min and the latter to 66.7 mL/min. The mixed gas to be separated was prepared on the assumption of the total splitting of water in an artificial photosynthesis plant equipped with a photocatalytic material, and the composition thereof was a stoichiometric composition of hydrogen:oxygen=2:1. Further, the supply pressure at this time was also varied as 0.06 MPa(G) and 0.1 MPa(G), and the performance as the gas separation process was also confirmed. At this time, the pressure on the permeation side of the separation membrane module was reduced to about −0.1 MPa(G) by all vacuum pumps. Further, the module temperature was set to 50° C., and the supply pressure dependency was confirmed.

The hydrogen permeance P(H₂) was found to be 2.15E-7 [mol/m²/sec/Pa], the oxygen permeance P(O₂) was found to be 5.58E-9 [mol/m²/sec/Pa], and the ratio α (H₂/O₂) was found to be 38.5, which were obtained from the condition of a supply pressure of 0.1 MPa(G).

Further, from the viewpoint of the gas separation process, under the condition of the supply pressure of 0.1 MPa(G), the permeation side flow rate was 135 mL/min, and the hydrogen concentration was 96%, and it was possible to set the outside of the detonation range (hydrogen concentration of 4% or more and less than 96%) of the hydrogen-oxygen mixed gas (hydrogen detonating gas). In addition, the hydrogen recovery rate was 97%.

On the other hand, the hydrogen permeance P(H₂) was found to be 2.26E-7 [mol/m²/sec/Pa], the oxygen permeance P(O₂) was found to be 6.12E-9 [mol/m²/sec/Pa], and the ratio α (H₂/O₂) was found to be 36.9, which were obtained from the condition of a supply pressure of 0.06 MPa(G), and values close to those in the case of the supply pressure of 0.1 MPa(G) were obtained.

Further, from the viewpoint of the gas separation process, under the condition of the supply pressure of 0.06 MPa(G), the permeation side flow rate was 127 mL/min, and the hydrogen concentration was 96%, and it was possible to set the outside of the detonation range (hydrogen concentration of 4% or more and less than 96%) of the hydrogen-oxygen mixed gas (hydrogen detonating gas). In addition, the hydrogen recovery rate was 92%.

In this way, high selectivity of hydrogen and oxygen, which cannot be achieved only by the CHA-type zeolite simple substance separation structure, was realized by the composite separation structure. At the same time, high hydrogen permeance was successfully maintained. Further, as a result, the hydrogen-oxygen mixed gas (hydrogen detonating gas) on the permeation side was successfully made to be outside of the detonation range (hydrogen concentration of 4% or more and 96% or less). In addition, by the lengthening of the composite separation structure, a hydrogen recovery rate of 92% to 97%, which is higher than that of Example 1, could be realized.

### Example 4

A composite separation structure was prepared by hydrothermal synthesis treatment and zeolite simple substance separation structure upper end portion treatment in the same manner as in Example 3. In order to confirm the structure near the upper end portion of the composite separation structure, a sample was processed as follows.

As in Example 2, TEM observation and density measurement of a cross-sectional portion near the surface of the composite separation structure were performed. As a result, it was found that the silica layer of the second separation section had an amorphous structure. The silica layer was 13 nm thick. As a result of the composition analysis by EDX, oxygen was 69.48 atomic %, aluminum was 1.63 atomic %, and silicon was 28.90 atomic %. The zeolite in the first separation section was 4.2 μm thick.

Further, the relative density of the second separation section (amorphous structure) was 1.200030392 (thick membrane portion) and 1.083727059 (thin membrane portion) when the CHA-type zeolite was taken as 1, and it was found that the material density was relatively higher than that of the CHA-type zeolite layer. Furthermore, it was found that the absolute density was 1.72 (g/cm³), which was a special layer having a density lower than that of commonly known amorphous silica. From these analyses, it is presumed that the amorphous silica layer formed on the zeolite simple substance separation structure by the method of the present inventors has a relatively higher material density than that of the zeolite layer, and thus can express extremely excellent performance as a gas separation membrane in that high hydrogen-oxygen separation performance can be expressed and relatively high hydrogen permeance can be realized because the absolute density is lower than that of normal amorphous silica.

### Example 5

A zeolite simple substance separation structure was prepared in the same manner as in the synthesis method shown in Example 2, and a tubular composite separation structure was prepared in the same manner as in Example 3 except for the supply gas flow rates in the treatment of the upper end portion thereof. The composite separation structure was mounted in a separation membrane module as a membrane length of 6.5 cm, and preparation for a gas separation experiment was completed.

In the experiment, a mixed gas of hydrogen and oxygen was used as a gas to be separated, and a total of 200.0 mL/min was supplied to the separation membrane by setting the former to 133.3 mL/min and the latter to 66.7 mL/min. The mixed gas to be separated was prepared on the assumption of the total splitting of water in an artificial photosynthesis plant equipped with a photocatalytic material, and the composition thereof was a stoichiometric composition of hydrogen:oxygen=2:1. In addition, the supply pressure at this time was set to 0.100 MPa(G). At this time, two evaluations were performed on the permeation side of the separation membrane module, one in the vicinity of atmospheric pressure and the other in the case where the pressure was reduced to about −0.100 MPa(G) by a vacuum pump. Further, the module temperature was set to 50° C., and the supply pressure dependency was confirmed.

The hydrogen permeance P(H₂) was found to be 2.14E-7 [mol/m²/sec/Pa], the oxygen permeance P(O₂) was found to be 4.14E-10 [mol/m²/sec/Pa], and the ratio α (H₂/O₂) was found to be 51.8, which were obtained from the conditions of a supply pressure of 0.100 MPa(G) and a permeation side atmospheric pressure (0.009 MPa(G)).

The hydrogen permeance P(H₂) was found to be 1.66E-7 [mol/m²/sec/Pa], the oxygen permeance P(O₂) was found to be 5.07E-9 [mol/m²/sec/Pa], and the ratio α (H₂/O₂) was found to be 32.8, which were obtained from the conditions of a supply pressure of 0.100 MPa(G) and a permeation side reduced pressure (−0.1000 MPa(G)).

### Example 6

A composite separation structure was prepared by the same hydrothermal synthesis treatment and upper end portion treatment as in Example 5. In order to confirm the structure near the surface of the composite separation structure, a sample was processed in the same manner as in Example 2. Further, TEM observation and density measurement of a cross-sectional portion near the surface of the composite separation structure were performed as in Example 2. As a result, it was found that the silica layer of the second separation section had an amorphous structure. The silica layer was 83 nm thick. Further, the relative density of the second separation section (amorphous structure) was 1.136775585 (thick membrane portion) and 1.107330694 (thin membrane portion) when the CHA-type zeolite was taken as 1, and it was found that the material density was relatively higher than that of the CHA-type zeolite layer. Furthermore, it was found that the absolute density was 1.69, which was a special layer having a density lower than that of commonly known amorphous silica. From these analyses, it is presumed that the amorphous silica layer formed on the zeolite simple substance separation structure by the method of the present inventors has a relatively higher material density than that of the zeolite layer, and thus can express extremely excellent performance as a gas separation membrane in that high hydrogen-oxygen separation performance can be expressed and relatively high hydrogen permeance can be realized because the absolute density is lower than that of normal amorphous silica.

### Example 7

A composite separation structure was prepared in the same manner as in Example 5. The composite separation structure was mounted in a separation membrane module as a membrane length of 7.98 cm, and preparation for a gas separation experiment was completed.

In the experiment, a mixed gas of hydrogen and oxygen was used as a gas to be separated, and a total of 200.0 mL/min was supplied to the separation membrane by setting the former to 133.3 mL/min and the latter to 66.7 mL/min. The mixed gas to be separated was prepared on the assumption of the total splitting of water in an artificial photosynthesis plant equipped with a photocatalytic material, and the composition thereof was a stoichiometric composition of hydrogen:oxygen=2:1. In addition, the supply pressure at this time was set to 0.100 MPa(G). At this time, two evaluations were performed on the permeation side of the separation membrane module, one in the vicinity of atmospheric pressure and the other in the case where the pressure was reduced to about −0.100 MPa(G) by a vacuum pump. Further, the module temperature was set to 50° C., and the supply pressure dependency was confirmed.

The hydrogen permeance P(H₂) was found to be 1.91E-7 [mol/m²/sec/Pa], the oxygen permeance P(O₂) was found to be 4.36E-9 [mol/m²/sec/Pa], and the ratio α (H₂/O₂) was found to be 43.7, which were obtained from the conditions of a supply pressure of 0.100 MPa(G) and a permeation side atmospheric pressure (0.009 MPa(G)).

The hydrogen permeance P(H₂) was found to be 1.49E-7 [mol/m²/sec/Pa], the oxygen permeance P(O₂) was found to be 5.29E-9 [mol/m²/sec/Pa], and the ratio α (H₂/O₂) was found to be 28.1, which were obtained from the conditions of a supply pressure of 0.1 MPa(G) and a permeation side reduced pressure (−0.1001 MPa(G)).

### Example 8

A composite separation structure was prepared by the same hydrothermal synthesis treatment and upper end portion treatment as in Example 3. Further, TEM observation and density measurement of a cross-sectional portion near the surface of the composite separation structure were performed as in Example 2. As a result, it was found that the silica layer of the second separation section had an amorphous structure. As a result of the composition analysis by EDX, oxygen was 71.07 atomic %, aluminum was 0.31 atomic % and silicon was 28.62 atomic %. The zeolite in the first separation section was 3.1 μm thick.

Further, the relative density was 1.146707016 (thick membrane portion) and 1.097183116 (thin membrane portion) when the CHA-type zeolite was taken as 1, and it was found that the material density was relatively higher than that of the CHA-type zeolite layer. Furthermore, it was found that the absolute density was 1.69, which was a special layer having a density lower than that of commonly known amorphous silica. From these analyses, it is presumed that the amorphous silica layer formed on the zeolite simple substance separation structure by the method of the present inventors has a relatively higher material density than that of the zeolite layer, and thus can express extremely excellent performance as a gas separation membrane in that high hydrogen-oxygen separation performance can be expressed and relatively high hydrogen permeance can be realized because the absolute density is lower than that of normal amorphous silica.

### Example 9

The membrane lengths of the composite separation structure described in Example 7 and the composite separation structure described in Example 5 were changed to 8.6 cm and 8.7 cm, respectively, and they were bonded using a metallic member so as not to cause gas leakage, thereby preparing a “composite separation structure connecting membrane” in which the composite separation structures were connected.

The composite separation structure had a total membrane length of 17.3 cm, and was mounted in a separation membrane module to complete preparation for a gas separation experiment.

In the experiment, a mixed gas of hydrogen and oxygen was used as a gas to be separated, and a total of 200.0 mL/min was supplied to the separation membrane by setting the former to 133.3 mL/min and the latter to 66.7 mL/min. The mixed gas to be separated was prepared on the assumption of the total splitting of water in an artificial photosynthesis plant equipped with a photocatalytic material, and the composition thereof was a stoichiometric composition of hydrogen:oxygen=2:1. In addition, the supply pressure at this time was set to 0.100 MPa(G), and the performance as the gas separation process was confirmed. At this time, the pressure on the permeation side of the separation membrane module was reduced to −0.0996 MPa(G) by a vacuum pump. Further, the module temperature was set to 50° C., and the gas separation process performance was confirmed.

As a result, the permeation side flow rate was 126.4 mL/min, the hydrogen concentration was 96.01%, and it was possible to set the outside of the detonation range (hydrogen concentration of 4% or more and less than 96%) of the hydrogen-oxygen mixed gas (hydrogen detonating gas). In addition, the hydrogen recovery rate was 91.02%.

In this way, high selectivity of hydrogen and oxygen, which cannot be achieved only by the CHA-type zeolite simple substance separation structure, was realized by the connecting membrane of the composite separation structure. As a result, the hydrogen-oxygen mixed gas (hydrogen detonating gas) on the permeation side was successfully made to be outside of the detonation range (hydrogen concentration of 4% or more and 96% or less). In addition, a hydrogen recovery rate of 91.02%, which is higher than that of Example 1, could be realized by the connecting of the composite separation structure.

### Example 10

A tubular CHA-type zeolite simple substance separation structure having an outer diameter of 12 mm and a length of 80 mm was prepared in the same manner as in Example 1. Four CHA-type zeolite simple substance separation structures were treated as follows to prepare a composite separation structure.

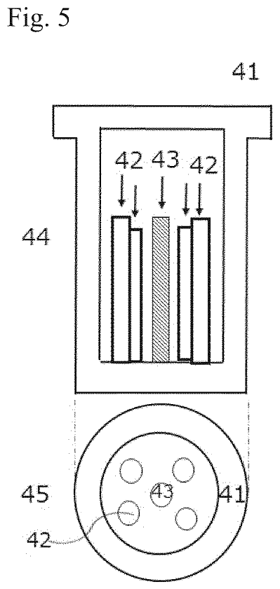

Hereinafter, a Teflon (registered trademark) inner cylinder sealed zeolite simple substance separation structure upper end portion treatment will be described. In the treatment procedure, first, a gas saturated with water vapor was supplied to the zeolite simple substance separation structure and the zeolite simple substance separation structure was subjected to water vapor adsorption under saturated conditions. Second, the zeolite simple substance separation structure (42 in FIG. 5) in which water vapor was adsorbed to saturation was placed in an upright position in a Teflon (registered trademark) inner cylinder having an internal volume of 200 mL. In the Teflon (registered trademark) inner cylinder (41 in FIG. 5), a porous tubular body impregnated in advance with polymethoxysiloxane (MKC (registered trademark) silicate, MS-56, manufactured by Mitsubishi Chemical Corporation), which is a methyl silicate oligomer serving as a silica raw material for upper end portion treatment, is installed in an upright state (43 in FIG. 5). Thirdly, the Teflon (registered trademark) inner cylinder container containing the zeolite simple substance separation structure having adsorbed water vapor and the porous tube impregnated with the silica raw material was sealed in an autoclave and kept in a constant temperature bath at 100° C. for 5 hours. Thereafter, the container was allowed to cool, and the upper end portion treated zeolite simple substance separation structure (composite separation structure) was taken out and further heat-treated at 130° C. for 1 hour.

Using the composite separation structure obtained, single component gas permeation performance of CO₂, H₂, N₂, and CH₄ was measured at 50° C. using the apparatus shown in FIG. 4, and further, air permeation separation was evaluated. The supply pressure is 0.1 MPaG, and the permeation side pressure is atmospheric pressure. Separation performance is defined as the ratio of the permeance of each single component gas. The obtained results are shown in Table 1. In Table 1, P[N₂] and P[O₂] are the respective permeance values of nitrogen and oxygen obtained by the measurement of air permeation separation performance, and [O₂]/[N₂] is a separation factor. H₂/[O₂] in the table is a separation factor (β) defined by Equation (3).

TABLE 1

| Sample | Sample measurement | Permeance [mol/m² · sec · Pa] | | | | | |
|---|---|---|---|---|---|---|---|
| number | conditions | P CO₂ | P H₂ | P N₂ | P CH₄ | P [O₂] | P [N₂] |
| Example 10-1 | Before modification | 3.3E−06 | 1.3E−06 | 2.2E−07 | 2.0E−08 | | |
| | treatment | | | | | | |
| | After modification | 1.4E−07 | 5.1E−07 | 4.3E−09 | 9.3E−10 | 2.4E−08 | 5.9E−09 |
| | treatment | | | | | | |
| Example 10-2 | Before modification | 3.5E−06 | 1.2E−06 | 2.2E−07 | 2.0E−08 | | |
| | treatment | | | | | | |
| | After modification | 1.6E−07 | 5.1E−07 | 4.4E−09 | 8.0E−10 | 1.5E−08 | 5.4E−09 |
| | treatment | | | | | | |

| | | |
|---|---|---|
| Sample | Ideal separation factor | Separation factor |

| number | CO₂/CH₄ | H₂/N₂ | H₂/CH₄ | [O₂]/[N₂] | H₂/[O₂] |
|---|---|---|---|---|---|
| Example 10-1 | 164 | 5.7 | 64 | | |
| | 147 | 118 | 543 | 4.0 | 22 |
| Example 10-2 | 175 | 5.3 | 58 | | |
| | 205 | 116 | 640 | 2.8 | 34 |

Using the apparatus shown in FIG. 4, the permeation separation performance of a mixed gas of hydrogen and oxygen was measured in the same manner as in Example 1 except that the pressure on the permeation side was set to atmospheric pressure. As a result, the hydrogen permeance was 3.58E-7 [mol/m²/sec/Pa], and the oxygen permeance was 1.52E-8 [mol/m²/sec/Pa]. The hydrogen-oxygen separation factor, i.e., the permeance ratio α (H₂/O₂) was 23.5.

### Example 11

A composite separation structure was prepared in the same manner as in Example 1. In the same manner as in Example 10 by using the apparatus shown in FIG. 4, single component gas permeation performance of H₂ and N₂ was measured at 50° C., and further, air permeation separation was evaluated. The supply pressure is 0.1 MPaG, and the permeation side pressure is atmospheric pressure. As a result, the hydrogen permeance was 2.95E-7 [mol/m²/sec/Pa], the nitrogen permeance was 7.77E-9 [mol/m²/sec/Pa], and the separation performance (permeance ratio) was 38. As a result of the air permeation separation performance measurement, the oxygen permeance was 1.4E-8 [mol/m²/sec/Pa], and the calculated β value (PH₂/P[O₂]; a ratio of the hydrogen permeance to the oxygen permeance obtained by the air separation measurement) was 21.

A thin piece for transmission electron microscope (TEM) observation was prepared by using an FIB (focused ion beam) processing apparatus for a cross-sectional portion near the surface of the composite separation structure, and the TEM observation of the cross-sectional portion of the upper end portion of the zeolite first separation section was performed under the condition of an acceleration voltage of 200 kV by using a transmission electron microscope (TEM), H-9500 manufactured by Hitachi High-Tech Corporation. As a result, a lattice image of the CHA-type zeolite crystal was confirmed, and an amorphous silica layer of 7.3 nm was observed on the surface of the zeolite crystal.

### Example 12

The zeolite simple substance separation structure obtained in the same manner as in Example 1 was treated at 100° C. in the same manner as in Example 2 except for the condition of the treatment time using the raw-material supply gas-flow-through zeolite simple substance separation structure upper end portion treatment apparatus shown in FIG. 2, thereby preparing a composite separation structure. That is, a zeolite simple substance separation structure upper end portion treatment was performed under three treatment conditions by supplying supply gases at 50 mL/min through a bubbler containing water vapor and a bubbler containing polymethoxysiloxane (MKC (registered trademark) silicate, MS-51, manufactured by Mitsubishi Chemical Corporation), which is a methyl silicate oligomer, as a silica source, respectively to a reaction tube in which the CHA-type zeolite simple substance separation structure was placed. The three treatment conditions were the “second treatment stage” defined in Example 2, that is, the time interval at which the gas accompanied by water vapor (50 mL/min) and the carrier gas accompanied by polymethoxysiloxane (50 mL/min) were mixed and supplied was set to 1 hour in Sample No. “Example 12-1”, 3 hours in Sample No. “Example 12-2”, and 5 hours in Sample No. “Example 12-3”. In the three treatments, the first stage and the third stage are each 1 hour, and the supply gas flow rate is 50 mL/min.

In the same manner as in Example 1, the composite separation structure obtained was subjected to measurement of single component gas permeation performance of CO₂, H₂, N₂, and CH₄ at 50° C. using the apparatus shown in FIG. 4, and further subjected to air separation evaluation. Separation performance is defined as the ratio of the permeance of each single component gas. The obtained results are shown in Table 2. In Table 2, P[N₂] and P[O₂] are the respective permeance values of nitrogen and oxygen obtained by the measurement of air permeation separation performance, and [O₂]/[N₂] is a separation factor. H₂/[O₂] in the table is a separation factor (β) defined by Equation (3).

The permeance of each of CO₂, H₂, and O₂ of the composite separation structure systematically decreases with the extension of the treatment time, and the ratio (β value) of the hydrogen permeance to the oxygen permeance obtained by the air separation measurement systematically increases. These results show that the permeation separation performance can be controlled by controlling the treatment time.

TABLE 2

| Sample | Sample measurement | Permeance [mol/m² · sec · Pa] | | | | | |
|---|---|---|---|---|---|---|---|
| number | conditions | P CO₂ | P H₂ | P N₂ | P CH₄ | P [O₂] | P [N₂] |
| Example 12-1 | Before modification | 2.9E−06 | 1.0E−06 | 1.8E−07 | 1.3E−08 | | |
| | treatment | | | | | | |
| | After modification | 1.0E−07 | 3.4E−07 | 2.6E−09 | 5.4E−10 | 1.1E−08 | 2.8E−09 |
| | treatment | | | | | | |
| Example 12-2 | Before modification | 3.1E−06 | 1.0E−06 | 1.9E−07 | 1.3E−08 | | |
| | treatment | | | | | | |
| | After modification | 2.9E−08 | 2.0E−07 | 1.4E−09 | 5.0E−10 | 3.8E−09 | 1.4E−09 |
| | treatment | | | | | | |
| Example 12-3 | Before modification | 3.1E−06 | 1.0E−06 | 1.7E−07 | 1.5E−08 | | |
| | treatment | | | | | | |
| | After modification | 9.0E−09 | 1.2E−07 | 1.1E−09 | 1.2E−09 | 1.9E−09 | 9.7E−10 |
| | treatment | | | | | | |

| | | |
|---|---|---|
| Sample | Ideal separation factor | Separation factor |

| number | CO₂/CH₄ | H₂/N₂ | H₂/CH₄ | [O₂]/[N₂] | H₂/[O₂] |
|---|---|---|---|---|---|
| Example 12-1 | 224 | 5.7 | 78 | | |
| | 192 | 128 | 625 | 3.9 | 31 |
| Example 12-2 | 235 | 5.6 | 78 | | |
| | 58 | 146 | 407 | 2.7 | 54 |
| Example 12-3 | 208 | 5.8 | 67 | | |
| | 7.4 | 104 | 97 | 2.0 | 62 |

### Example 13

A composite separation structure was prepared in the same manner as in Example 3 except for the conditions of the raw material supply gas flow rate and the Si raw material. That is, the treatment was performed under four conditions in which the supply gas was set to 25 mL/min, 50 mL/min, 75 mL/min, and 100 mL/min respectively through a bubbler containing water vapor and a bubbler containing polymethoxysiloxane (MKC (registered trademark) silicate, MS-56, manufactured by Mitsubishi Chemical Corporation), which is a methyl silicate oligomer, as a silica source, respectively.

Single component gas permeation evaluation and air permeation separation evaluation were performed in the same manner as in Example 10 using the obtained composite separation structure. The obtained results are shown in Table 3. In Table 3, P[N₂] and P[O₂] are the respective permeance values of nitrogen and oxygen obtained by the measurement of air permeation separation performance, and [O₂]/[N₂] is a separation factor. H₂/[O₂] in the table is a separation factor (β) defined by Equation (3).

There is a correlation between supply gas flow rate and performance. That is, as the supply gas flow rate increases, the gas permeability of each component tends to decrease, and the hydrogen/nitrogen separation performance tends to increase. From these results, it is found that the technique is capable of controlling the performance of the membrane obtained by the treatment by controlling the supply gas flow rate.

TABLE 3

| | Membrane | | | Sample | | | | | | |
|---|---|---|---|---|---|---|---|---|---|---|
| Treatment | sample | Length | Position in | measurement | Permeance [mol/m² · sec · Pa] | | | | | |
| number | number | [cm] | treatment | conditions | P CO₂ | P H₂ | P N₂ | P CH₄ | P [O₂] | P [N₂] |
| Example | 1311 | 40 | | Before | 2.8E−06 | 1.0E−06 | 1.7E−07 | 1.5E−08 | | |
| 13-1 | | | | modification | | | | | | |
| | | | | treatment | | | | | | |
| | 1312 | 40 | Overall | After | 3.9E−08 | 1.9E−07 | 2.0E−09 | 1.0E−09 | 5.8E−09 | 2.1E−09 |
| | | | | modification | | | | | | |
| | | | | treatment | | | | | | |
| Example | 1321 | 40 | | Before | 2.3E−06 | 9.1E−07 | 1.6E−07 | 1.4E−08 | | |
| 13-2 | | | | modification | | | | | | |
| | | | | treatment | | | | | | |
| | 1322 | 20 | Upstream | After | 1.2E−07 | 3.5E−07 | 4.3E−09 | 1.5E−09 | 1.3E−08 | 4.4E−09 |
| | | | | modification | | | | | | |
| | | | | treatment | | | | | | |
| | 1323 | 20 | Downstream | After | 9.9E−08 | 3.4E−07 | 3.2E−09 | 1.3E−09 | | |
| | | | | modification | | | | | | |
| | | | | treatment | | | | | | |
| Example | 1331 | 40 | | Before | 3.2E−06 | 1.1E−06 | 2.0E−07 | 1.9E−08 | | |
| 13-3 | | | | modification | | | | | | |
| | | | | treatment | | | | | | |
| | 1332 | 20 | Upstream | After | 1.9E−07 | 4.4E−07 | 4.7E−09 | 7.4E−10 | 1.7E−08 | 5.1E−09 |
| | | | | modification | | | | | | |
| | | | | treatment | | | | | | |
| | 1333 | 20 | Downstream | After | 2.2E−07 | 4.4E−07 | 6.9E−09 | 2.2E−09 | 1.8E−08 | 7.4E−09 |
| | | | | modification | | | | | | |
| | | | | treatment | | | | | | |
| Example | 1341 | 40 | | Before | 3.1E−06 | 1.0E−06 | 1.8E−07 | 1.8E−08 | | |
| 13-4 | | | | modification | | | | | | |
| | | | | treatment | | | | | | |
| | 1342 | 20 | Upstream | After | 2.2E−07 | 5.8E−07 | 1.2E−08 | 3.0E−09 | 2.7E−08 | 1.3E−08 |
| | | | | modification | | | | | | |
| | | | | treatment | | | | | | |
| | 1343 | 20 | Downstream | After | 2.7−E07 | 4.9E−07 | 8.5E−09 | 1.5E−09 | 1.7E−08 | 9.2E−09 |
| | | | | modification | | | | | | |
| | | | | treatment | | | | | | |

| | | |
|---|---|---|
| Treatment | Ideal separation factor | Separation factor |

| number | CO₂/CH₄ | H₂/N₂ | H₂/CH₄ | [O₂]/[N₂] | H₂/[O₂] |
|---|---|---|---|---|---|
| Example | 183 | 5.8 | 66 | | |
| 13-1 | 19 | 91 | 185 | 2.8 | 32 |
| Example | 165 | 5.7 | 66 | | |
| 13-2 | 76 | 82 | 229 | 2.9 | 28 |
| | 77 | 106 | 261 | | |
| Example | 167 | 5.6 | 58 | | |
| 13-3 | 262 | 94 | 602 | 3.4 | 26 |
| | 97 | 63 | 195 | | |
| Example | 174 | 5.7 | 58 | | |
| 13-4 | 73 | 47 | 195 | 2.1 | 21 |
| | 189 | 58 | 338 | 1.8 | 30 |

### Example 14

A composite separation structure obtained in the same manner as in Example 10 was immersed in hot water at 100° C. for 1 hour. In the same manner as in Example 10, the gas permeation performance was measured before and after the immersion in hot water to confirm the change in performance. The results are shown in Table 4. Before and after the immersion in hot water, a decrease in hydrogen permeance and a decrease in hydrogen/nitrogen separation performance were not observed. A decrease in performance of the composite separation structure due to the immersion in hot water was not observed.

TABLE 4
Performance change before and after hot water treatment

| | | | |
|---|---|---|---|
| | Hydrogen | Nitrogen | Permeance |
| Hot water | permeance | permeance | ratio |

| | | |
|---|---|---|
| treatment | [mol/m² · sec · Pa] | [—] |

| | | | |
|---|---|---|---|
| Before | 1.6E−7 | 2.1E−09 | 77 |
| After | 1.8E−07 | 2.4E−09 | 72 |

### Example 15

Using the composite separation structure obtained in the same manner as in Example 10, the permeation separation performance was measured using the apparatus shown in FIG. 4 under the conditions of 50° C., a supply gas pressure of 0.1 MPaG, and a permeation side atmospheric pressure in a mixed gas of 200 mL/min of hydrogen and 100 mL/min of nitrogen containing water vapor having a relative humidity of 10%. The obtained permeation separation results are shown in Table 5. In the permeated gas, the hydrogen permeance was 9.0E-8 [mol/m²/sec/Pa], and the water vapor permeance was 9.1E-7 [mol/m²/sec/Pa], which was about 10 times larger than the hydrogen permeance.

TABLE 5
Membrane permeation separation performance

| | | |
|---|---|---|
| Water vapor permeance | Hydrogen permeance | Nitrogen permeance |

[mol/m² · sec · Pa]

| | | |
|---|---|---|
| 9.1E−7 | 0.9E−7 | 1.9E−9 |

### Example 16

Using the composite separation structure obtained by the same method as in Example 10 and using the apparatus shown in FIG. 4, a continuous measurement of permeation of helium containing water vapor having a relative humidity of 10% was performed under the conditions of 50° C. and a supply gas pressure of 0.1 MPaG for 6,700 hours by cumulative time. The permeation separation performance of the membrane before and after the cumulative 6,700 hours was measured using the apparatus shown in FIG. 4 under the conditions of 50° C. and a supply gas pressure of 0.1 MPaG in a mixed gas of hydrogen and nitrogen containing water vapor having a relative humidity of 10%. The results are shown in Table 6.

TABLE 6

| | Membrane permeation separation performance | | |
|---|---|---|---|
| | Hydrogen | Nitrogen | |
| Measurement | permeance | permeance | Permeance |
| timing | [mol/m² · sec · Pa] | | ratio |
| Before continuous | 8.8E−08 | 5.3E−09 | 17 |
| measurement | | | |
| 6,700 hours later | 9.0E−08 | 3.3E−09 | 27 |

### Example 17

In the same manner as in Example 1, the apparatus shown in FIG. 2 was used to treat the upper end portion of a CHA-type zeolite simple substance separation structure of a tubular shape (outer diameter: 12 mm, inner diameter: 9 mm) having a length of 20 cm. The composite separation structure of a tubular shape (outer diameter: 12 mm, inner diameter: 9 mm) having a length of 20 cm obtained by the treatment was subjected to measurement of single component gas permeation performance of CO₂, H₂, N₂, and CH₄ at 50° C. using the apparatus shown in FIG. 4 in the same manner as in Example 10, and further subjected to air separation evaluation. In addition, measurement of single component gas permeation performance of CO₂, H₂, and N₂ was performed at 130° C. The results are shown in Table 7. High H₂/CO₂ separation performance was confirmed. In Table 7, P[N₂] and P[O₂] are the respective permeance values of nitrogen and oxygen obtained by the measurement of air permeation separation performance, and separation factor [O₂]/[N₂] is a separation factor. The separation factor H₂/[O₂] is a separation factor (β) defined by Equation (3).

TABLE 7

| | Sample | Measurement | | | | | | | |
|---|---|---|---|---|---|---|---|---|---|
| Sample | measurement | temperature | Permeance [mol/m² · sec · Pa] | | | | | | |
| number | conditions | [° C.] | P CO₂ | P H₂ | P N₂ | P CH₄ | P He | P [O₂] | P [N₂] |
| Example | Before | 50 | 2.7E−06 | 8.7E−07 | 1.5E−07 | 1.5E−08 | | | |
| 17-1 | modification | | | | | | | | |
| | treatment | | | | | | | | |
| | After | 130 | 3.2E−09 | 2.6E−07 | 1.5E−09 | | 2.1E−07 | | |
| | modification | | | | | | | | |
| | treatment | | | | | | | | |
| | After | 50 | 2.6E−08 | 1.7E−07 | 9.8E−10 | 4.7E−10 | 1.8E−07 | 3.8E−09 | 9.9E−10 |
| | modification | | | | | | | | |
| | treatment | | | | | | | | |

| | | |
|---|---|---|
| Sample | Ideal separation factor | Separation factor |

| number | CO₂/CH₄ | H₂/N₂ | H₂/CH₄ | H₂/CO₂ | [O₂]/[N₂] | H₂/[O₂] |
|---|---|---|---|---|---|---|
| Example | 182 | 5.7 | 59 | | | |
| 17-1 | | | | 83 | | |
| | 56 | 174 | 367 | 6.6 | 3.8 | 46 |

### Example 18

The sample prepared in Example 2 was analyzed as follows. A HADFF-STEM image covering the first separation section and the second separation section from the upper end side to the lower end side was acquired by adjusting the sample-thickness 120 nm.

Regarding this image, a histogram of the number of pixels was obtained for each of the first separation section and the second separation section as the luminance at an 8-bit grayscale and the frequency thereof. In each histogram, a luminance range indicating the number of pixels of 1% or more of the maximum frequency was defined as a peak range, and an average value of the number of pixels in this range was obtained. The sum of the absolute number of dissociations from this average value in the peak range was calculated as the variance.

The ratio of the variance of the second separation section to that of the first separation section was then calculated as the ratio of variance in density. As a result, the “ratio of variance in density” of the sample prepared in Example 2 was 0.009.

### Example 19

The sample prepared in Example 2 was analyzed as follows. The luminance (0 to 255) in an 8-bit grayscale for the second separation section acquired in Example 18 and a histogram of the number of pixels as a frequency corresponding thereto were acquired, and a 5-unit moving average processing and an interpolation processing such that the number of luminance categories becomes 1000 were performed. A luminance category range showing the number of pixels of 1% or more of the maximum frequency was defined as a peak range, and an average value of the number of pixels in this range was obtained. At this time, on the high luminance side of the peak range, that is, on the high density side, a ratio of the sum of frequency values of regions showing a frequency smaller than this average value to the sum of frequency values of other regions was calculated, and this was defined as a “ratio of high-density region”. As a result, the sample prepared in Example 2 had a value of 0.067.

### Example 20

The analysis performed in Example 18 was also performed on the sample prepared in Example 4. The “ratio of variance in density” of the sample was 0.004.

The analysis performed in Example 19 was performed on the sample prepared in Example 4. The “ratio of high-density region” of this sample was 0.064.

### Comparative Example 1

A CHA-type zeolite simple substance separation structure having a length of 80 mm obtained by the same synthesis method as in Example 1 was surface-treated as follows in accordance with the description of Examples in JP 2015-44162 A (PTL 1).

A solution obtained by mixing 30% by mass of a polymethoxysiloxane (MKC (registered trademark) silicate, MS-51, manufactured by Mitsubishi Chemical Corporation) which is a methyl silicate oligomer with isopropyl alcohol was immersed for about 5 seconds in the CHA-type zeolite simple substance separation structure having an air hole at the upper end face and a hole-free lower end face, and then pulled up. Thereafter, the CHA-type zeolite simple substance separation structure was air-dried, placed vertically in a Teflon (registered trademark) inner cylinder containing about 1 g of water at the bottom, sealed, heated at 100° C. for 6 hours, allowed to cool after the lapse of a predetermined time, taken out, and further heat-treated at 150° C. for 1 hour.

In the same manner as in Example 10, using the composite separation structure obtained, single component gas permeation performance of CO₂, H₂, N₂, and CH₄ was measured at 50° C. using the apparatus shown in FIG. 4, and further, air permeation separation was evaluated. The supply pressure is 0.1 MPaG, and the permeation side pressure is atmospheric pressure. Separation performance is defined as the ratio of the permeance of each single component gas. The obtained results are shown in Table 8. In Table 8, P[N₂] and P[O₂] are the respective permeance values of nitrogen and oxygen obtained by the measurement of air permeation separation performance, and [O₂]/[N₂] is a separation factor. H₂/[O₂] in the table is a separation factor (β) defined by Equation (3).

TABLE 8

| | Sample | | | | | | |
|---|---|---|---|---|---|---|---|
| Sample | measurement | Permeance [mol/m² · sec · Pa] | | | | | |
| number | conditions | P CO₂ | P H₂ | P N₂ | P CH₄ | P [O₂] | P [N₂] |
| Comparative | Before | 3.3E−06 | 1.1E−06 | 1.9E−07 | 1.8E−08 | | |
| Example 1 | modification | | | | | | |
| | treatment | | | | | | |
| | After | 1.4E−06 | 6.0E−07 | 1.1E−07 | 8.3E−09 | 1.3E−07 | 1.1E−07 |
| | modification | | | | | | |
| | treatment | | | | | | |

| | | |
|---|---|---|
| Sample | Ideal separation factor | Separation factor |

| number | CO₂/CH₄ | H₂/N₂ | H₂/CH₄ | [O₂]/[N₂] | H₂/[O₂] |
|---|---|---|---|---|---|
| Comparative | 179 | 5.8 | 60 | | |
| Example 1 | 166 | 5.5 | 72 | 1.1 | 4.7 |

As is clear from Table 8, in the sample obtained by immersing the CHA-type zeolite membrane in a solution in which polymethoxysiloxane as a silica source was dissolved in isopropyl alcohol to modify the surface, a practical separation performance was not obtained.

Next, a continuous gas separation experiment in which the gas to be separated (gas) was a mixed gas of hydrogen and oxygen was performed in the same manner as in Example 1, except that the composite separation structure prepared by the above method was mounted in a separation membrane module as a membrane length of 5.7 cm, the permeation side of the separation membrane module was set to atmospheric pressure, and the separation experiment was performed for 2.5 hours, and the measurement was performed after the lapse of the time.

As a result, the hydrogen permeance P(H₂) was found to be 3.84E-7 [mol/m²/sec/Pa], the oxygen permeance P(O₂) was found to be 1.06E-7 [mol/m²/sec/Pa], and the ratio α (H₂/O₂) was found to be a low value of 3.6.

Further, the hydrogen concentration after 2.5 hours was 76.8%, and it was not possible to set the outside of the detonation range (hydrogen concentration of 4% or more and 96% or less) of the hydrogen-oxygen mixed gas (hydrogen detonating gas). In addition, although the membrane length was longer than that in Example 1, the hydrogen recovery rate was as low as 31.4%.

As described above, when the surface treatment was performed according to the description of Examples in JP 2015-44162 A (PTL 1), high selectivity of hydrogen and oxygen could not be realized. Further, as a result, the hydrogen-oxygen mixed gas (hydrogen detonating gas) on the permeation side could not be set outside of the detonation range (hydrogen concentration of 4% or more and 96% or less).

The analysis performed in Example 18 was also performed on the sample prepared in Comparative Example 1. The “ratio of variance in density” of the sample was 0.097.

The analysis performed in Example 19 was also performed on the sample prepared in Comparative Example 1. The ratio of high-density region of this sample was 0.112.

### REFERENCE SIGNS LIST

1: Container (bubbler) for generating gas from Si compound
2: Container (bubbler) for generating water vapor from water
3: Tubular reaction tube
4: Gas flow rate controller
5: Water vapor collector in exhaust gas
6: Back pressure valve
7: Gas flow meter
8: Valve
9: Supply gas
10: Exhaust gas
11: Constant temperature bath
21: Tubular reaction tube
22: Zeolite simple substance separation structure
23: Fixing jig
24: Flange
25: Supply gas inlet pipe
26: Exhaust gas pipe
31: Zeolite separation structure
32: Pressure-resistant container
33: End pin
34: Connection section
35: Pressure gauge
36: Back pressure valve
37: Supply gas
38: Permeated gas
39: Sweep gas
340: Discharge gas
341: Pipe
342: Pipe
41: Teflon (registered trademark) inner cylinder
42: Zeolite simple substance separation structure having adsorbed water vapor
43: Porous tube impregnated with silica raw material
44: Vertical section schematic view
45: Horizontal section schematic view
100: Composite separation structure
101: Substrate section
102: Void section
103: First separation section
104: Second separation section
105: Separation active section
106: Simple substance separation structure

1. A composite separation structure comprising a substrate section, a first separation section disposed in contact with the substrate section, and a second separation section disposed not in contact with the substrate section but in contact with the first separation section, wherein the second separation section has an amorphous structure.

2. A composite separation structure comprising a substrate section, a first separation section disposed in contact with the substrate section, and a second separation section disposed not in contact with the substrate section but in contact with the first separation section, wherein the second separation section is amorphous and has a thickness from an end portion in contact with the first separation section to the opposite end portion of 5 nm or more and 200 nm or less.

3. A composite separation structure comprising a substrate section, a first separation section disposed in contact with the substrate section, and a second separation section disposed not in contact with the substrate section but in contact with the first separation section, wherein the second separation section is amorphous and has a relative density of 1.05 or more and 1.30 or less with respect to the first separation section.

4. A composite separation structure comprising a substrate section, a first separation section disposed in contact with the substrate section, and a second separation section disposed not in contact with the substrate section but in contact with the first separation section, wherein the second separation section is amorphous and has an absolute density of 1.58 g/cm³ or more and 1.96 g/cm³ or less.

5. The composite separation structure of claim 1, wherein the substrate section is an inorganic porous material.

6. The composite separation structure of claim 1, wherein the first separation section is zeolite.

7. The composite separation structure according to claim 6, wherein the zeolite is a zeolite having a 6-membered oxygen ring structure or an 8-membered oxygen ring structure.

8. The composite separation structure of claim 6, wherein the zeolite is in the form of a membrane.

9. The composite separation structure according to claim 8, wherein a membrane thickness of the zeolite is 0.1 μm or more and 100 μm or less.

10. The composite separation structure of claim 1, wherein main constituent elements of the second separation section are Si and O.

11. The composite separation structure according to claim 10, wherein the second separation section is in the form of a membrane.

12. The composite separation structure according to claim 11, wherein the second separation section is a silica membrane having a membrane thickness of 5 nm or more and 200 nm or less.

13. The composite separation structure of claim 1, wherein hydrogen detonating gas having a hydrogen-to-oxygen ratio of 2 and a pressure of 0.2 MPa(G) or less is separated such that a ratio α (H₂/O₂) of hydrogen permeance to oxygen permeance is 10 or more and 110 or less.

14. A method for producing the composite separation structure of claim 1, the method comprising: forming the first separation section in contact with the substrate section; and then forming the second separation section by exposing an end portion of the first separation section on a side opposite to a side in contact with the substrate section to a gas containing a molecular compound having at least a Si atom.

15. The method for producing a composite separation structure according to claim 14, wherein the gas containing a molecular compound having a Si atom further contains water vapor.

16. The method for producing a composite separation structure of claim 14, wherein the end portion of the first separation section on the side opposite to the side in contact with the substrate section is exposed to water vapor before being exposed to the gas containing the molecular compound having a Si atom, and the end portion of the second separation section on the side opposite to the side in contact with the first separation section is exposed to water vapor after the second separation section is formed.

17. The method for producing a composite separation structure of claim 14, wherein all the steps are performed at 200° C. or lower.

18. A separation or concentration method comprising: allowing hydrogen to permeate from a gas to be separated containing at least hydrogen and oxygen by using the composite separation structure of claim 1.

19. The separation or concentration method according to claim 18, wherein the hydrogen-to-oxygen ratio in the gas to be separated is 2, and the pressure thereof is 0.2 MPa(G) or less.

20. (canceled)

21. The separation or concentration method of claim 18, wherein a pressure on a permeation side where hydrogen permeates and a hydrogen concentration increases is reduced.

22. The separation or concentration method of claim 18, wherein a hydrogen concentration on a permeation side where hydrogen permeates and a hydrogen concentration increases is 96% or more, and a hydrogen recovery rate defined by a ratio of an amount of hydrogen on the permeation side to an amount of hydrogen contained in the gas to be separated is 80% or more.

23. A separation or concentration method comprising: allowing hydrogen to permeate from a gas to be separated containing at least hydrogen and carbon dioxide by using the composite separation structure of claim 1.

24. (canceled)

25. A composite separation structure comprising a substrate section, a first separation section disposed in contact with the substrate section, and a second separation section having an amorphous structure and disposed not in contact with the substrate section but in contact with the first separation section, wherein hydrogen detonating gas having a hydrogen-to-oxygen ratio of 2 and a pressure of 0.2 MPa(G) or less is separated such that a ratio α (H₂/O₂) of hydrogen permeance to oxygen permeance is 10 or more and 110 or less.

26-27. (canceled)
